(19) United States
(12) Patent Application Publication
(10) Pub. No.: US 2026/0092738 A1
(43) Pub. Date: Apr. 2, 2026

(54) DRYING DEVICE AND DRYING METHOD

(71) Applicant: BROTHER KOGYO KABUSHIKI KAISHA, Nagoya (JP)

(72) Inventors: Masatoshi TOYODA, Nagoya (JP); Takahiro SHIMIZU, Kariya (JP); Haruki YANAGITA, Okazaki (JP)

(21) Appl. No.: 19/340,339

(22) Filed: Sep. 25, 2025

(30) Foreign Application Priority Data
Sep. 30, 2024 (JP) 2024-171149
Sep. 16, 2025 (JP) 2025-153022

(51) Int. Cl. F26B 25/22; D06F 58/38; D06F 103/04

(52) U.S. Cl. CPC F26B 25/225; D06F 58/38; D06F 2103/04

(57) ABSTRACT

A processor of a drying device performs drying processing of drying fabric to which a pre-treatment liquid is applied until a target dryness factor is within a range of 82% to 95%, inclusive. The target dryness factor indicates a ratio of a target change amount to a weight of a target liquid. The weight of the target liquid indicates a total obtained by adding together a weight of a solvent component contained in the pre-treatment liquid applied to the fabric at a time point preceding the drying processing and a weight of moisture contained in a region of the fabric to which the pre-treatment liquid is applied at a time point preceding application of the pre-treatment liquid to the fabric. The target change amount indicates an amount by which a weight of the region of the fabric changes as a result of the drying processing.

### REFERENCE TO RELATED APPLICATIONS

This application claims priority from Japanese Patent Application No. 2024-171149 filed on Sep. 30, 2024 and Japanese Patent Application No. 2025-153022 filed on Sep. 16, 2025. The entire content of the priority application is incorporated herein by reference.

### BACKGROUND ART

An inkjet printing method includes a pre-treatment process, a drying process, and a printing process. The pre-treatment process, the drying process, and the printing process are performed in the order of the pre-treatment process, the drying process, and the printing process. The pre-treatment process applies a pre-treatment liquid to a print medium. The drying process dries the print medium to which the pre-treatment liquid has been applied. The printing process performs printing on the dried print medium.

### SUMMARY

In the above-described inkjet printing method, depending on the degree of drying of the pre-treatment liquid in the drying process, the color development of an image printed on the print medium in the printing process may deteriorate.

Embodiments of the broad principles derived herein provide a drying device and a drying method that contribute to improving color development of a printed image.

A first aspect of the present disclosure relates to a drying device. The drying device includes a dryer configured to dry a fabric to which a pre-treatment liquid is applied prior to application of an ink containing a pigment to the fabric. The drying device includes a processor and a memory storing computer-readable instructions that, when executed by the processor, cause the processor to perform a process. The process includes drying processing of controlling the dryer to dry the fabric to which the pre-treatment liquid is applied until a target dryness factor is within a range of 82% to 95%, inclusive. The target dryness factor indicates a ratio of a target change amount to a weight of a target liquid. The weight of the target liquid indicates a total obtained by adding together a weight of a solvent component contained in the pre-treatment liquid applied to the fabric at a time point preceding the drying processing and a weight of moisture contained in a region of the fabric to which the pre-treatment liquid is applied at a time point preceding application of the pre-treatment liquid to the fabric. The target change amount indicates an amount by which a weight of the region of the fabric changes as a result of the drying processing.

According to the first aspect, the fabric is conveyed to a printing process in a state in which the target dryness factor is within the range of 82% to 95%, inclusive. Thus, the drying device contributes to improving color development of a printed image.

A second aspect of the present disclosure relates to a drying method for controlling a drying device. The drying device includes a dryer configured to dry a fabric to which a pre-treatment liquid is applied prior to application of an ink containing a pigment to the fabric. The drying method includes drying processing of controlling the dryer to dry the fabric to which the pre-treatment liquid is applied until a target dryness factor is within a range of 82% to 95%, inclusive. The target dryness factor indicates a ratio of a target change amount to a weight of a target liquid. The weight of the target liquid indicates a total obtained by adding together a weight of a solvent component contained in the pre-treatment liquid applied to the fabric at a time point preceding the drying processing and a weight of moisture contained in a region of the fabric to which the pre-treatment liquid is applied at a time point preceding application of the pre-treatment liquid to the fabric. The target change amount indicates an amount by which a weight of the region of the fabric changes as a result of the drying processing.

The second aspect contributes to the same advantages as the first aspect.

### BRIEF DESCRIPTION OF DRAWINGS

FIG. 1 is a plan diagram schematically showing a print system.

FIG. 2 is a block diagram showing an electrical configuration of a drying device.

FIG. 3 is a diagram illustrating behavior of a coagulant in drying processing.

FIG. 4 is a diagram illustrating behavior of a resin component in the drying processing.

FIG. 5 is a diagram illustrating formation states of a white ink layer in print processing, for each of evaporation amounts of a solvent component.

FIG. 6 is a diagram showing a fabric.

FIG. 7 is a table showing a calculation method of an initial moisture content of the fabric.

FIG. 8 includes tables showing a calculation method of each of parameters of a first working example.

FIG. 9 is a table showing results of L* value evaluation experiments and color difference evaluation experiments.

FIG. 10 is a graph showing the results of the L* value evaluation experiments where the horizontal axis is a target dryness factor and the vertical axis is a target L* value.

FIG. 11 is a graph showing the results of the L* value evaluation experiments where the horizontal axis is a primary dryness factor, and the vertical axis is the target L* value.

FIG. 12 is a graph showing the results of the color difference evaluation experiments where the horizontal axis is a primary heat amount, and the vertical axis is a target color difference ΔE*ab.

FIG. 13 is a flowchart of main processing.

FIG. 14 is a diagram showing primary drying setting information.

FIG. 15 is a diagram showing secondary drying setting information.

### DESCRIPTION

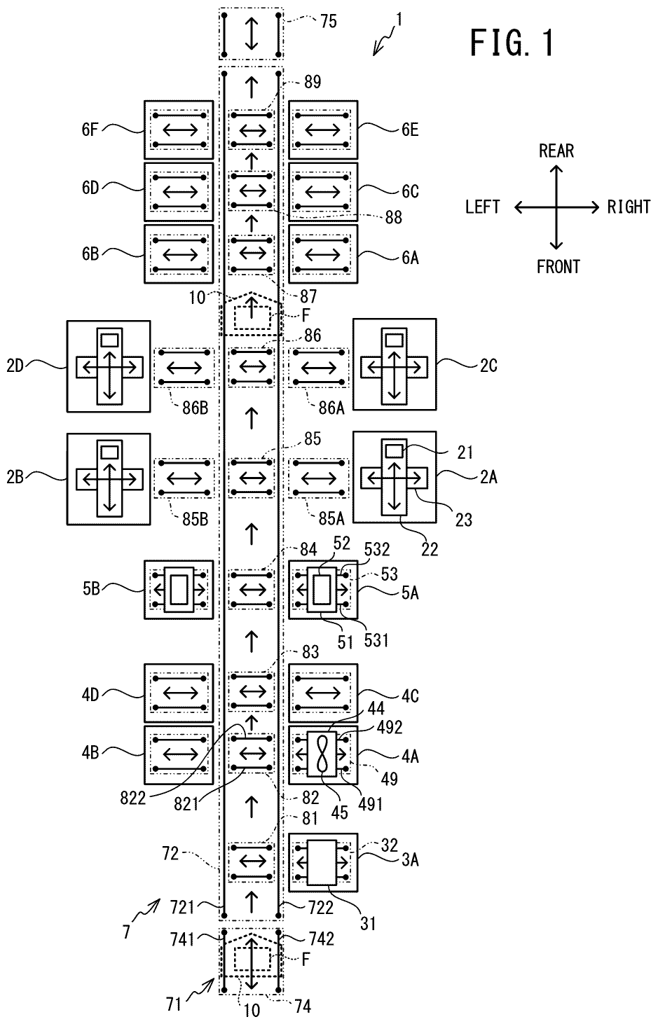

A print system 1 according to an embodiment of the present disclosure will be described with reference to the drawings. The print system 1 shown in FIG. 1, is a system that, while conveying multiple platens 10, sequentially performs processing, on fabrics F respectively placed on the platens 10. The processing includes pre-processing, print processing, and post-processing. The print system 1 performs the pre-processing, the print processing, and the post-processing, in the order of the pre-processing, the print processing, and the post-processing.

In the pre-processing, application processing and drying processing are performed in the order of the application processing and the drying processing. The drying processing according to the present embodiment is performed in two stages. The drying processing includes oven processing and heat press processing. The oven processing and the heat press processing are performed in the order of the oven processing and the heat press processing.

Hereinafter, the oven processing will be referred to as “primary drying processing”. The heat press processing will be referred to as “secondary drying processing”. Each processing step will be described in detail later.

The configuration of the print system 1 will be described with reference to FIG. 1. In FIG. 1, the upward direction, the downward direction, the leftward direction, the rightward direction, a depth direction (into the page), and a front direction (out of the page) correspond to a rearward direction, a forward direction, a leftward direction, a rightward direction, a downward direction, and an upward direction of the print system 1, respectively.

The print system 1 includes multiple printers 2A, 2B, 2C, and 2D, an application device 3A, multiple gas-fired ovens 4A, 4B, 4C, and 4D, multiple heat press devices 5A and 5B, multiple post-processing devices 6A, 6B, 6C, 6D, 6E, and 6F, a conveyance device 7, and the platens 10.

The platens 10 have a plate shape. The platens 10 extend in the front-rear direction and the left-right direction. A fabric F is placed on a platen 10. The material of the fabric F is, for example, 100% cotton. The platen 10 is conveyed by the conveyance device 7.

Each of the printers 2A, 2B, 2C, and 2D is a device that performs the print processing. The print processing is an operation in which a liquid ink is applied to the fabric F on the platen 10 to print an image. Hereinafter, the image printed on the fabric F by the print processing will be referred to as a “printed image.” In the present embodiment, each of the printers 2A, 2B, 2C, and 2D is an inkjet printer. Each of the printers 2A, 2B, 2C, and 2D performs the printing on the fabric F on the platen 10.

The printer 2A is disposed further to the right than a main path 71 to be described below. For example, a surface in which an entry port for the platen 10 into each of the printers 2A, 2B, 2C, and 2D is formed is a front surface. In this case, the left surface of the printer 2A is the front surface of the printer 2A.

The printer 2B is disposed to the left of the printer 2A. The front surface of the printer 2B faces the front surface of the printer 2A, with the main path 71 interposed therebetween.

The printer 2C is disposed to the rear of the printer 2A. The front surface of the printer 2C is oriented in the same direction as the front surface of the printer 2A.

The printer 2D is disposed to the left of the printer 2C. The front surface of the printer 2D faces the front surface of the printer 2C, with the main path 71 interposed therebetween.

The printers 2A, 2B, 2C and 2D have the same structure. Thus, hereinafter, the structure of the printer 2A will be described as a representative example, and a description of the structure of the printers 2B, 2C, and 2D will be omitted. The printer 2A includes an inkjet head 21, a main scanning conveyance mechanism 22, and a sub-scanning conveyance mechanism 23.

The inkjet head 21 includes nozzles. The inkjet head 21 discharges ink from the nozzles as a result of being driven by head drive elements. The colors of the ink are, for example, white (W), black (K), yellow (Y), cyan (C), and magenta (M). The ink forms the printed image.

The ink may further include spot colors. The spot colors are, for example, orange (OR) and green (GR).

The main scanning conveyance mechanism 22 conveys the inkjet head 21 in the main scanning direction by driving a main scanning motor. In the printer 2A, the main scanning direction is the front-rear direction. The sub-scanning conveyance mechanism 23 conveys the platen 10 in the sub-scanning direction by driving a sub-scanning motor. In the printer 2A, the sub-scanning direction is the left-right direction.

The printer 2A controls the main scanning conveyance mechanism 22 and the sub-scanning conveyance mechanism 23 to move the fabric F relative to the inkjet head 21 in the main scanning direction and the sub-scanning direction. The printer 2A controls the inkjet head 21 and discharges the ink from the nozzles, while moving the fabric F relative to the inkjet head 21. In this way, the print processing is performed in which the ink is applied to the fabric F, and the image is printed on the fabric F.

The application device 3A is a device that performs application processing. The application processing is performed before the print processing. The application processing is an operation in which a pre-treatment liquid is applied to the fabric F. In other words, the pre-treatment liquid is applied to the fabric F before the ink is applied to the fabric F.

The pre-treatment liquid is a base coat agent. The pre-treatment liquid improves ink fixation and color development on the fabric F.

The application device 3A is disposed further to the right than the main path 71, at a position further to the front than the printer 2A. For example, a surface in which the entry port for the platen 10 is formed is the front surface of the application device 3A. In this case, the left surface of the application device 3A is the front surface of the application device 3A.

The application device 3A includes an application portion 31, and a conveyance path 32. The application portion 31 is a spray in the present embodiment. The application portion 31 sprays the pre-treatment liquid. The application portion 31 may be, for example, a discharge head or an application spatula.

The conveyance path 32 branches to the right from the main path 71 to be described later, and extends to the application device 3A. The conveyance path 32 conveys the platen 10 in the left-right direction by driving a conveyance motor of the conveyance path 32. The conveyance path 32 has the same structure as a conveyance path 49 to be described later. Thus, a description of the structure of the conveyance path 32 will be omitted here.

In the application device 3A, in a state in which the platen 10 has been disposed directly below the application portion 31 by the conveyance path 32, the application portion 31 sprays the pre-treatment liquid onto the fabric F on the platen 10. In this way, the application processing in which the pre-treatment liquid is applied to the fabric F is performed.

Each of the gas-fired ovens 4A, 4B, 4C, and 4D is a device that performs oven processing. The oven processing is performed after the application processing, and before the print processing. The oven processing is an operation in which the fabric F is dried under a high-temperature atmosphere, thereby evaporating solvent component of the pre-treatment liquid applied to the fabric F during the application processing. This improves the fixation of solute in the pre-treatment liquid to the fabric F.

The gas-fired ovens 4A, 4B, 4C, and 4D are disposed, in the front-rear direction, between the printers 2A and 2B, and the application device 3A. Positional relationships of each of the gas-fired ovens 4A, 4B, 4C, and 4D are the same as the positional relationships of each of the printers 2A, 2B, 2C, and 2D.

The gas-fired ovens 4A, 4B, 4C, and 4D have the same structures as each other. Thus, the structure of the gas-fired oven 4A will be described as an example, and a description of the gas-fired ovens 4B, 4C, and 4D will be omitted.

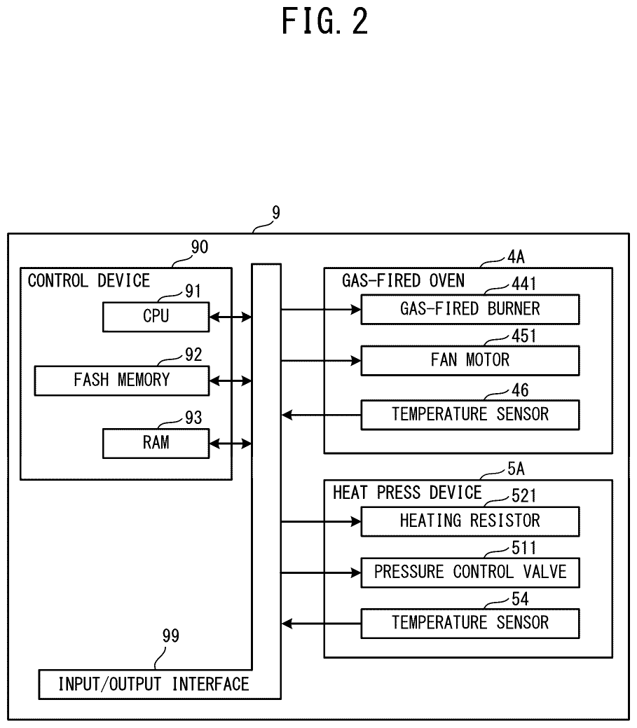

The gas-fired oven 4A includes a heater 44, a fan 45, and the conveyance path 49. The heater 44 includes a gas-fired burner 441 shown in FIG. 2. The heater 44 heats the air inside the gas-fired oven 4A through operation of the gas-fired burner 441.

The fan 45 is an air blower. The fan 45 includes a fan motor 451 shown in FIG. 2. When the fan motor 451 is driven, the fan 45 blows the air heated by the heater 44 toward the fabric F on the platen 10 inside the gas-fired oven 4A. In this way, the gas-fired oven 4A performs the oven processing that dries the fabric F using a non-contact method.

The conveyance path 49 branches to the right from the main path 71 to be described later, and extends to the gas-fired oven 4A. The conveyance path 49 conveys the platen 10 in the left-right direction by driving a conveyance motor of the conveyance path 49. Thus, a conveyance direction of the conveyance path 49 is the left-right direction.

In the present embodiment, the conveyance path 49 is defined by belt conveyors 491 and 492. The belt conveyor 491 is disposed at the front end of the conveyance path 49. The belt conveyor 492 is disposed at the rear end of the conveyance path 49. The belt conveyors 491 and 492 extend in the left-right direction in parallel with each other. Rotation shafts of each of the belt conveyors 491 and 492 extend in the front-rear direction.

Each of the heat press devices 5A and 5B is a device that performs heat press processing. The heat press processing is performed after the oven processing, and before the print processing.

The heat press processing is an operation in which the fabric F is pressed at a high temperature to evaporate the solvent component of the pre-treatment liquid remaining in the fabric F in the oven processing. This improves the fixation of the solute in the pre-treatment liquid to the fabric F. Furthermore, the heat press processing is an operation in which the nap on the printed surface of the fabric F is flattened to smooth out the printed surface of the fabric F. This improves print quality on the fabric F by the printers 2A, 2B, 2C, and 2D.

The heat press devices 5A and 5B are disposed, in the front-rear direction, between the printers 2A and 2B, and the gas-fired ovens 4C and 4D. The positional relationship between the heat press devices 5A and 5B is similar to the positional relationship between the printers 2A and 2B.

The heat press devices 5A and 5B have the same structure. Thus, hereinafter, the structure of the heat press device 5A will be described and a description of the structure of the heat press device 5B will be omitted.

The heat press device 5A includes a heater 52, a press portion 51, and a conveyance path 53. The heater 52 includes a heating resistor 521 shown in FIG. 2. The heater 52 heats the press portion 51 through operation of the heating resistor 521.

The press portion 51 has a plate shape. The press portion 51 includes a pressure control valve 511 shown in FIG. 2. The press portion 51 moves in the up-down direction as a result of pneumatic or hydraulic pressure through operation of the pressure control valve 511.

The press portion 51 moves downward in a state of being heated by the heater 52 to contact a front surface of the fabric F. As a result, the press portion 51 heats the fabric F, and also applies pressure to the fabric F against the platen 10. In this way, the heat press device 5A performs the heat press processing that dries the fabric F using a contact method.

The conveyance path 53 branches to the right from the main path 71 to be described later, and extends to the heat press device 5A. The conveyance path 53 conveys the platen 10 in the left-right direction by driving a conveyance motor of the conveyance path 53. The structure of the conveyance path 53 is the same as that of the conveyance path 49. Thus, a description of the structure of the conveyance path 53 will be omitted.

In the heat press device 5A, in a state in which the platen 10 is positioned directly below the press portion 51 by the conveyance path 53, the press portion 51 heated by the heater 52 presses the fabric F. In this way, the heat press processing is performed in which the fabric F is pressed at a high temperature.

Each of the post-processing devices 6A, 6B, 6C, 6D, 6E, and 6F is a device that performs post-processing. The post-processing is performed after the print processing. The post-processing is an operation in which the fabric F is dried in a high temperature atmosphere to evaporate moisture content in the ink applied to the fabric F by the print processing. In this way, the fixation of pigment in the ink to the fabric F is improved.

The post-processing devices 6A, 6B, 6C, 6D, 6E, and 6F are disposed further to the rear than the printers 2C and 2D. The positional relationships of each of the post-processing devices 6A, 6B, 6C, and 6D are the same as the positional relationships of each of the printers 2A, 2B, 2C, and 2D.

Furthermore, the post-processing devices 6E and 6F are arranged in the left-right direction with the main path 71 interposed therebetween. The post-processing devices 6E and 6F are disposed to the rear of the post-processing devices 6C and 6D. Each of the post-processing devices 6A, 6B, 6C, 6D, 6E, and 6F has the same structure as the gas-fired oven 4A. Thus, a description of the structure of the post-processing devices 6A, 6B, 6C, 6D, 6E, and 6F will be omitted.

The conveyance device 7 conveys the platens 10 such that the application processing, the oven processing, the heat press processing, the print processing, and the post-processing are sequentially performed. The conveyance device 7 includes the main path 71 and transfer mechanisms 81 to 89.

The main path 71 has a two-level structure. The main path 71 includes forward path 72, a return path, and elevator mechanisms 74 and 75. The forward path 72 is a second level portion, and extends in the front-rear direction from a position further to the front than the application device 3A to a position further to the rear than the post-processing devices 6E and 6F. The return path is a first level portion, and extends in the front-rear direction from a position further to the front than the application device 3A to a position further to the rear than the post-processing devices 6E and 6F. In other words, the return path is disposed directly below the forward path 72, and extends in parallel to the forward path 72.

The forward path 72 conveys the platen 10 from the front toward the rear by driving a conveyance motor for the forward path 72. In the present embodiment, the forward path 72 is defined by belt conveyors 721 and 722.

The belt conveyor 721 is disposed at the left end of the forward path 72. The belt conveyor 722 is disposed at the right end of the forward path 72. The belt conveyors 721 and 722 extend in the front-rear direction in parallel to each other. Rotation shafts of each of the belt conveyors 721 and 722 extend in the left-right direction.

The return path has the same structure as the forward path 72. The return path conveys the platen 10 from the rear toward the front by driving a conveyance motor for the return path.

The elevator mechanism 74 is disposed at the front end of the main path 71. The elevator mechanism 75 is disposed at the rear end of the main path 71. Thus, the forward path 72 and the return path are disposed between the elevator mechanism 74 and the elevator mechanism 75 in the front-rear direction.

The elevator mechanisms 74 and 75 move up and down, driven by respective lifting motors, to a position at the same height as the forward path 72 and a position at the same height as the return path. The position at the same height as the forward path 72 indicates the second level portion. The position at the same height as the return path indicates the first level portion. Furthermore, the elevator mechanisms 74 and 75, driven by respective conveyance motors, convey the platen 10 in the front-rear direction.

In the present embodiment, the elevator mechanism 74 is constituted by belt conveyors 741 and 742. The belt conveyor 741 is disposed at the left end of the elevator mechanism 74. The belt conveyor 742 is disposed at the right end of the elevator mechanism 74. The belt conveyors 741 and 742 extend in the front-rear direction in parallel to each other. Rotation shafts of each of the pair of belt conveyors 741 and 742 extend in the left-right direction.

The elevator mechanism 75 has the same structure as the elevator mechanism 74. Thus, a description of the structure of the elevator mechanism 75 will be omitted.

The transfer mechanisms 81 to 89 are disposed between the belt conveyors 721 and 722 in the left-right direction. The transfer mechanisms 81 to 89 are arranged in the order of the transfer mechanisms 81, 82, 83, 84, 85, 86, 87, 88, and 89, from the front to the rear, on the forward path 72.

Each of the transfer mechanisms 81 to 89 conveys the platen 10 in the left-right direction, and transfers the platen 10 between the forward path 72 and a conveyance mechanism or path of a corresponding device adjacent to the forward path 72. For example, the transfer mechanism 81 transfers the platen 10 between the forward path 72 and the conveyance path 32 of the application device 3A.

The transfer mechanism 82 transfers the platen 10 between the forward path 72 and the conveyance path 49 of the gas-fired oven 4A. Furthermore, the transfer mechanism 82 transfers the platen 10 between the forward path 72 and a conveyance path of the gas-fired oven 4B.

The transfer mechanism 84 transfers the platen 10 between the forward path 72 and the conveyance path 53 of the heat press device 5A. Furthermore, the transfer mechanism 84 transfers the platen 10 between the forward path 72 and a conveyance path of the heat press device 5B.

The transfer mechanism 85 transfers the platen 10 between the forward path 72 and the sub-scanning conveyance mechanism 23 of the printer 2A, via a connecting conveyance path 85A. Furthermore, the transfer mechanism 85 transfers the platen 10 between the forward path 72 and a sub-scanning conveyance mechanism of the printer 2B, via a connecting conveyance path 85B.

The transfer mechanism 86 transfers the platen 10 between the forward path 72 and a sub-scanning conveyance mechanism of the printer 2C, via a connecting conveyance path 86A. Furthermore, the transfer mechanism 86 transfers the platen 10 between the forward path 72 and a sub-scanning conveyance mechanism of the printer 2D, via a connecting conveyance path 86B.

The transfer mechanisms 81 and 83 to 89 each have the same structure as the transfer mechanism 82. Thus, hereinafter, the structure of the transfer mechanism 82 will be described as a representative example, and a description of the structure of the transfer mechanisms 81 and 83 to 89 will be omitted.

In the present embodiment, the transfer mechanism 82 moves up and down between a position lower than the forward path 72 and a position higher than the forward path 72, by driving a lifting motor of the transfer mechanism 82. Furthermore, by driving a rotation motor, the transfer mechanism 82 rotates the platen 10 on the transfer mechanism 82 in the clockwise direction or the counterclockwise direction in plan view.

In the present embodiment, the transfer mechanism 82 is constituted by belt conveyors 821 and 822. The belt conveyor 821 is disposed at the front end of the transfer mechanism 82. The belt conveyor 822 is disposed at the rear end of the transfer mechanism 82. The belt conveyors 821 and 822 extend in the left-right direction in parallel to each other. Rotation shafts of each of the belt conveyors 821 and 822 extend in the front-rear direction.

A flow of operations by the print system 1 will be described with reference to FIG. 1. Hereinafter, for convenience, at the start of the operations by the print system 1, each of the transfer mechanisms 81 to 89 is positioned lower than the forward path 72, and each of the elevator mechanisms 74 and 75 is positioned at the same height as the forward path 72.

A user attaches the fabric F to a platen 10 located on the elevator mechanism 74. The elevator mechanism 74 conveys the platen 10 toward the rear, and transfers the platen 10 to the forward path 72.

The forward path 72 conveys the platen 10 rearward to the transfer mechanism 81. The transfer mechanism 81 moves up to a position higher than the forward path 72. In this way, the platen 10 is transferred from the forward path 72 to the transfer mechanism 81. The transfer mechanism 81 rotates the platen 10 in the clockwise direction by 90° in plan view, and conveys the platen 10 to the right. In this way, the platen 10 is transferred from the transfer mechanism 81 to the conveyance path 32.

The application device 3A performs the application processing. When the application processing by the application device 3A is complete, the conveyance path 32 conveys the platen 10 to the left, and transfers the platen 10 to the transfer mechanism 81. The transfer mechanism 81 rotates the platen 10 in the counterclockwise direction by 90° in plan view, and moves down to a position lower than the forward path 72. In this way, the platen 10 is transferred from the transfer mechanism 81 to the forward path 72.

Each of the transfer mechanisms 82 to 89 transfers the platen 10 in the same manner as the transfer mechanism 81. Thus, hereinafter, a description of the transfer manner of the platen 10 by each of the transfer mechanisms 82 to 89 will be omitted or simplified.

The forward path 72 conveys the platen 10 rearward to the transfer mechanism 82 or to the transfer mechanism 83. Which of the transfer mechanisms 82 and 83 the platen 10 is conveyed to is determined based on which of the gas-fired ovens 4A, 4B, 4C, and 4D is to perform the oven processing. For example, a case will be described in which the oven processing is to be performed by the gas-fired ovens 4A. In this case, the platen 10 is conveyed to the transfer mechanism 82, and is transferred to the transfer mechanism 82 from the forward path 72. The transfer mechanism 82 conveys the platen 10 in the rightward direction, and transfers the platen 10 to the conveyance path 49.

The gas-fired oven 4A executes the oven processing. When the oven processing by the gas-fired oven 4A is complete, the conveyance path 49 conveys the platen 10 leftward and transfers the platen 10 to the transfer mechanism 82. The transfer mechanism 82 transfers the platen 10 to the forward path 72.

The forward path 72 conveys the platen 10 rearward, and transfers the platen 10 to the transfer mechanism 84. For example, a case will be described in which the heat press processing is to be performed by the heat press device 5A. In this case, the transfer mechanism 84 conveys the platen 10 rightward and transfers the platen 10 to the conveyance path 53.

The heat press device 5A performs the heat press processing. When the heat press processing by the heat press device 5A is complete, the conveyance path 53 conveys the platen 10 leftward and transfers the platen 10 to the transfer mechanism 84. The transfer mechanism 84 transfers the platen 10 to the forward path 72.

The forward path 72 conveys the platen 10 rearward to the transfer mechanism 85 or the transfer mechanism 86. Which of the transfer mechanisms 85 and 86 the platen 10 is conveyed to is determined based on which of the printers 2A, 2B, 2C, and 2D is to perform the print processing. For example, in a case where the print processing is performed by the printer 2A, the platen 10 is conveyed to the transfer mechanism 85, and is transferred to the transfer mechanism 85 from the forward path 72. The transfer mechanism 85 conveys the platen 10 rightward and transfers the platen 10 to the sub-scanning conveyance mechanism 23 via the connecting conveyance path 85A.

The printer 2A performs the print processing. When the print processing by the printer 2A is complete, the sub-scanning conveyance mechanism 23 conveys the platen 10 in the leftward direction, and transfers the platen 10 to the transfer mechanism 85 via the connecting conveyance path 85A. The transfer mechanism 85 transfers the platen 10 to the forward path 72.

The forward path 72 conveys the platen 10 rearward and transfers the platen 10 to the transfer mechanism 87, the transfer mechanism 88, or the transfer mechanism 89. Which of the transfer mechanisms 87, 88, and 89 the platen 10 is conveyed to is determined based on which of the post-processing devices 6A, 6B, 6C, 6D, 6E, and 6F performs the post-processing. For example, a case will be described in which the post-processing is to be performed by the post-processing device 6A. In this case, the platen 10 is conveyed to the transfer mechanism 87, and is transferred to the transfer mechanism 87 from the forward path 72. The transfer mechanism 87 conveys the platen 10 in the rightward direction, and transfers the platen 10 to a conveyance path of the post-processing device 6A.

The post-processing device 6A performs the post-processing. When the post-processing by the post-processing device 6A is complete, the conveyance path of the post-processing device 6A conveys the platen 10 in the leftward direction, and transfers the platen 10 to the transfer mechanism 87. The transfer mechanism 87 transfers the platen 10 to the forward path 72.

The forward path 72 conveys the platen 10 in the rearward direction, and transfers the platen 10 to the elevator mechanism 75. The elevator mechanism 75 moves down to the same height as the return path. The elevator mechanism 75 conveys the platen 10 in the forward direction, and transfers the platen 10 to the return path. In a state in which the elevator mechanism 74 is located at the same height as the return path, the return path conveys the platen 10 in the forward direction, and transfers the platen 10 to the elevator mechanism 74.

The user removes the fabric F, on which the image has been printed, from the platen 10, during a period in which the platen 10 is conveyed from the elevator mechanism 75 to the elevator mechanism 74 via the return path. For example, the user removes the fabric F, on which the image has been printed, from the platen 10 located on the elevator mechanism 75. Subsequently, the user attaches the fabric F to the platen 10 in a state in which the platen 10 is disposed on the elevator mechanism 74. Thereafter, the similar operations by the print system 1 are repeated.

The electrical configuration of a drying device 9 will be described with reference to FIG. 2. The drying device 9 is a unit including a control device 90, the gas-fired oven 4A, and the heat press device 5A. The control device 90 includes a CPU 91, a flash memory 92, and a RAM 93.

The CPU 91 controls the drying device 9. The CPU 91 functions as a processor. The CPU 91, the flash memory 92, and the RAM 93 are electrically connected to each other.

The flash memory 92 is a non-volatile memory. The flash memory 92 stores various types of information. For example, programs are stored in the flash memory 92.

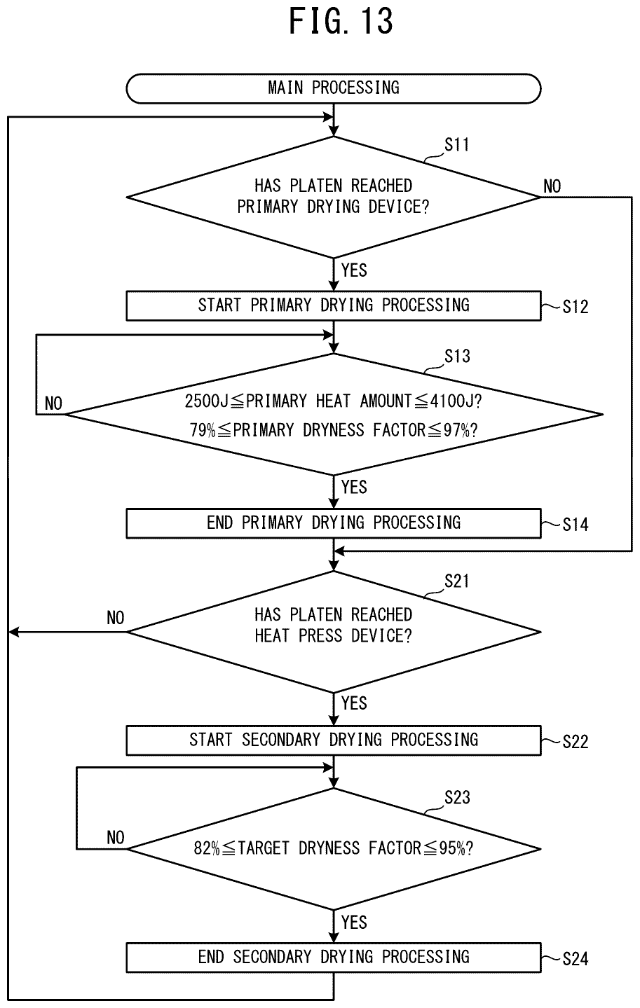

The programs consist of computer-readable instructions. The programs are executed by the CPU 91. When the programs are executed by the CPU 91, the programs instruct the CPU 91 to perform various types of processing. The programs include a control program for executing main processing to be described later and shown in FIG. 13.

The RAM 93 is a volatile memory. The RAM 93 temporarily stores data. For example, the data includes information calculated, acquired, specified, determined, received, or accepted in the main processing.

Each of the gas-fired burner 441, the fan motor 451, and a temperature sensor 46 of the gas-fired oven 4A is electrically connected to the CPU 91, via an input/output interface 99. The gas-fired burner 441 generates heat under the control of the CPU 91. The fan motor 451 is driven under the control of the CPU 91.

The temperature sensor 46 detects the temperature of atmospheric air inside the gas-fired oven 4A. The temperature sensor 46 outputs a signal to the CPU 91 indicating the detected temperature. The CPU 91 controls the heating temperature of the gas-fired burner 441 based on the signal from the temperature sensor 46.

Furthermore, each of the heating resistor 521, the pressure control valve 511, and a temperature sensor 54 of the heat press device 5A is electrically connected to the CPU 91, via the input/output interface 99. The heating resistor 521 generates heat under the control of the CPU 91. The pressure control valve 511 adjusts a magnitude of a pressurizing pressure applied by the press portion 51 under the control of the CPU 91.

The temperature sensor 54 detects the temperature of the press portion 51. The temperature sensor 54 outputs a signal to the CPU 91 indicating the detected temperature. The CPU 91 controls the heating temperature of the heating resistor 521 based on the signal from the temperature sensor 54.

In the present embodiment, the gas-fired ovens 4B, 4C, and 4D have the same electrical configuration as the gas-fired oven 4A. The heat press device 5B has the same electrical configuration as the heat press device 5A. Thus, in a similar manner to the gas-fired oven 4A and the heat press device 5A, each of the gas-fired ovens 4B, 4C, and 4D and the heat press device 5B are also electrically connected to the CPU 91 via the input/output interface 99.

Furthermore, the printers 2A to 2D may also be electrically connected to the CPU 91. The application device 3A may also be electrically connected to the CPU 91. The post-processing devices 6A to 6F may also be electrically connected to the CPU 91. The conveyance device 7 may also be electrically connected to the CPU 91. For example, when the conveyance device 7 is electrically connected to the CPU 91, the CPU 91 may control each of the motors of the conveyance device 7.

White ink will now be described in detail. The white ink contains a white pigment. The white pigment is a white coloring agent. The white pigment may be hollow particles, or may be non-hollow particles. The white pigment may contain both the hollow particles and the non-hollow particles.

The hollow particles may be, for example, JSR Corporation's “SX-866 (B)” (styrene acrylic dispersing liquid, pigment solid content blending amount 20 wt %, primary particle size 0.3 μm) or “SX-868 (B)” (styrene acrylic dispersing liquid, pigment solid content blending amount 20 wt %, primary particle size 0.5 μm), Rohm and Haas Company's “ROPAQUE ULTRA E” (styrene acrylic dispersing liquid, pigment solid content blending amount 30 wt %, primary particle size 0.4 μm), or Zeon Corporation's “NIPOL V1004” (modified styrene-butadiene dispersing liquid, pigment solid content blending amount 50 wt %, primary particle size 0.3 μm), “NIPOL MH8055” (styrene acrylic dispersing liquid, pigment solid content blending amount 30 wt %, primary particle size 0.8 μm), or “NIPOL MH5055” (styrene acrylic dispersing liquid, pigment solid content blending amount 30 wt %, primary particle size 0.5 μm). ROPAQUE is a registered trademark of Rohm and Haas Company. NIPOL is a registered trademark of Zeon Corporation. Note that the primary particle size indicates the volume average particle diameter.

For example, the non-hollow particles may be titanium oxide, silicon dioxide, zinc oxide, aluminum oxide, magnesium oxide, barium sulfate, or calcium carbonate.

The white ink may further contain a polymeric dispersant obtained by an anionic water-soluble resin being neutralized with a basic compound. The anionic water-soluble resin is a copolymer obtained, for example, by causing a mixture of one or two types of a carboxyl group-containing unsaturated monomer and one or two types of an unsaturated monomer to react with each other.

The carboxyl group-containing unsaturated monomer is, for example, acrylic acid, methacrylic acid, itaconic acid, maleic acid, maleic anhydride, a maleic acid monoalkyl ester, citraconic acid, citraconic anhydride, or a citraconic acid monoalkyl ester. Note that the carboxyl group-containing unsaturated monomer includes an acid anhydride group-containing unsaturated monomer that forms a carboxyl group through ring opening.

The unsaturated monomer is, for example, a styrene monomer, aralkyl methacrylate, alkyl methacrylate, or acrylate. The styrene monomer is, for example, styrene, α-methylstyrene, or vinyltoluene. The aralkyl methacrylate is, for example, benzyl methacrylate, or benzyl acrylate. The alkyl methacrylate is, for example, acrylate, methyl methacrylate, butyl methacrylate, 2-ethylhexyl methacrylate, stearyl methacrylate, laurel methacrylate, methyl acrylate, butyl acrylate, 2-ethylhexyl acrylate, stearyl acrylate, or laurel acrylate.

The basic compound is, for example, an alkali metal hydroxide, or an organic basic compound. The alkali metal hydroxide is, for example, sodium hydroxide or potassium hydroxide. The organic basic compound is, for example, triethylamine, monoethanolamine, triethanolamine, or triethylenediamine.

A usage amount of the polymeric dispersant is, for example, 10 to 40 parts by weight per 100 parts by weight of the white pigment. A usage amount of the polymeric dispersant is, for example, 15 to 30 parts by weight per 100 parts by weight of the white pigment.

In a total amount of the white ink, a total solid component amount obtained by combining the white pigment, the polymeric dispersant, a resin component, a nonionic resin emulsion, and an anionic resin emulsion is 25 wt % to 45 wt %, for example.

The white ink may contain a humectant, a surfactant, an acidity regulator, a viscosity modifier, a surface tension modifier, a preservative, or an antifungal agent. The humectant contributes to preventing drying out of the white ink, for example. The humectant is, for example, ketoalcohol, polyalkylene glycol, polyhydric alcohol, 2-pyrrolidone, N-methyl 2-pyrrolidone, or 1,3-Dimethyl-2-imidazolidinone. The ketoalcohol is diacetone alcohol, for example. The polyhydric alcohol is an alkylene glycol, glycerine, or trimethylolpropane, for example.

The polyalkylene glycol is polyethylene glycol, or polypropylene glycol, for example. The alkylene glycol is ethylene glycol, propylene glycol, diethylene glycol, triethylene glycol, dipropylene glycol, tripropylene glycol, thiodiglycol, or hexylene glycol, for example.

The humectant may be one type, or may be two or more types. The humectant is preferably polyhydric alcohol. The content of the humectant in the total white ink amount is from 0 wt % to 60 wt %, for example. The content of the humectant in the total white ink amount is from 3 wt % to 50 wt %, for example.

The surfactant contributes to adjusting a surface tension of the white ink and improving dispersibility of the white pigment. The surfactant may be one type, or may be two or more types.

The pre-treatment liquid will be described in detail. The pre-treatment liquid contains a solvent component, a water-soluble component, a dispersing component, and an additive component. The solvent component satisfies the conditions of being a liquid at room temperature, and evaporating during the drying processing.

The solvent component includes water and an organic solvent, for example. The water improves handling of the pre-treatment liquid and improves stability of storage. The boiling point of the organic solvent is higher than the boiling point of the water.

For example, the organic solvent is 1,3-propanediol, diglycerine, glycerine, ethylene glycol, diethylene glycol, propylene glycol, butylene glycol, hexylene glycol, triethylene glycol, polyethylene glycol, dipropylene glycol, tripropylene glycol, polypropylene glycol, 1,5-Pentanediol, or 1,2,6-Hexanetriol.

The water-soluble component contains a coagulant and a surfactant. The coagulant coagulates the ink, and improves the color development performance of the ink. Note that, in the present embodiment, a high color development performance of the ink means that the color of the ink develops in a vivid manner. For example, the high color development performance of the white ink means that the L* value in the L*a*b color space is high.

The coagulant is a polyvalent metal salt. The polyvalent metal salt is, for example, calcium salt, magnesium salt, or aluminum salt.

The calcium salt is, for example, calcium chloride, calcium bromide, calcium iodide, calcium nitrite, calcium nitrate, monobasic calcium phosphate, calcium thiocyanate, calcium acetate, calcium lactate, calcium fumarate, or calcium citrate. The calcium salt may be a hydrate of calcium chloride, calcium bromide, calcium iodide, calcium nitrite, calcium nitrate, monobasic calcium phosphate, calcium thiocyanate, calcium acetate, calcium lactate, calcium fumarate, or calcium citrate, for example.

The magnesium salt is, for example, magnesium chloride, magnesium bromide, magnesium iodide, magnesium sulfate, magnesium acetate, or magnesium nitrate. The magnesium salt may be a hydrate of magnesium chloride, magnesium bromide, magnesium iodide, magnesium sulfate, magnesium acetate, or magnesium nitrate, for example.

The aluminum salt is, for example, aluminum chloride, aluminum bromide, aluminum sulfate, aluminum nitrate, or aluminum acetate. The aluminum salt may be a hydrate of aluminum chloride, aluminum bromide, aluminum sulfate, aluminum nitrate, or aluminum acetate, for example.

The polyvalent metal salt may contain one type of polyvalent metal salt. The polyvalent metal salt may contain two or more types of polyvalent metal salt.

For example, from a viewpoint of suppressing a color change of the fabric F caused by the pre-treatment, the polyvalent metal salt preferably contains the calcium salt, contains the magnesium salt, or contains both the calcium salt and the magnesium salt. For example, from a viewpoint of the color development of the image printed by the print processing and from a viewpoint of cost, the polyvalent salt preferably contains the calcium salt.

The surfactant is, for example, a nonionic surfactant. The nonionic surfactant is, for example, an acetylene glycol-based surfactant. The nonionic surfactant may be a commercial product. Examples of the commercial product include Nissin Chemical Industry Co. Ltd.'s “Olfine E1004”, “Olfine ( ) E1006”, “Olfine E1010”, “Olfine E1020”, “Olfine EXP4001”, “Olfine EXP4200”, “Olfine EXP4123”, “Olfine EXP4300”, “Olfine PD-001”, “OlfinePD-002 W”, “Olfine PD-005”, “Surfynol 420”, “Surfynol 440”, “Surfynol 465”, and “Surfynol 485”. Olfine is a registered trademark of Nissin Chemical Industry Co. Ltd. Surfynol is a registered trademark of Evonik Operations GmbH.

Instead of the nonionic surfactant, or in addition to the nonionic surfactant, the surfactant may contain a surfactant other than the nonionic surfactant. Examples of the surfactant other than the nonionic surfactant include an anionic surfactant, a cationic surfactant, and an amphoteric surfactant.

The dispersing component includes a resin component. The resin component is a water-based resin. Examples of the water-based resin include an acrylate resin, a maleic acid ester resin, a vinyl acetate resin, a carbonate resin, a polycarbonate resin, a styrene resin, an ethylene resin, a polyethylene resin, a propylene resin, a polypropylene resin, a urethane resin, or a polyurethane resin. The water-based resin may be a copolymer resin of the acrylate resin, the maleic acid ester resin, the vinyl acetate resin, the carbonate resin, the polycarbonate resin, the styrene resin, the ethylene resin, the polyethylene resin, the propylene resin, the polypropylene resin, the urethane resin, or the polyurethane resin, for example.

The water-based resin may be a commercial product, for example. The commercial product is, for example, Japan Coating Resin Corporation's “Mowinyl 6770”, “Mowinyl 7320”, “Mowinyl 966A”, “Mowinyl 6963”, or “Mowinyl 6960”, or Nissin Chemical Industry Co. Ltd.'s “Vinyblan GV-6181” or “Vinyblan GV-1002”, or DIC Corporation's “Voncoat SFC-55” or “Voncoat SFC-571”. Mowinyl is a trademark of Japan Coating Resin Corporation, which unregistered in the United States and is registered in Japan. Vinyblan is a registered trademark of Nissin Chemical Industry Co. Ltd. Voncoat is a registered trademark of DIC Corporation.

The dispersing component may contain one type of the water-based resin. The dispersing component may contain two or more types of the water-based resin.

The additive component is, for example, a crosslinking agent, an acidity regulator, a viscosity modifier, an antiseptic agent, or an antifungal agent. For example, the antiseptic agent suppresses the occurrence of mold in the pre-treatment liquid, and suppresses the pre-treatment liquid from becoming corroded.

Note that, of the additive components, a component satisfying conditions of being liquid at room temperature, and evaporating in the drying processing corresponds to the solvent component. The additive component that corresponds to the solvent component will also be referred to as an “additive corresponding to the solvent component”. The additive corresponding to the solvent component is, for example, a room-temperature liquid added as the acidity regulator. The room-temperature liquid added as the acidity regulator is, for example, water contained in hydrochloric acid or ammonia water.

Of each of the types described above, the pre-treatment liquid preferably contains at least the solvent component, the coagulant, and the resin component.

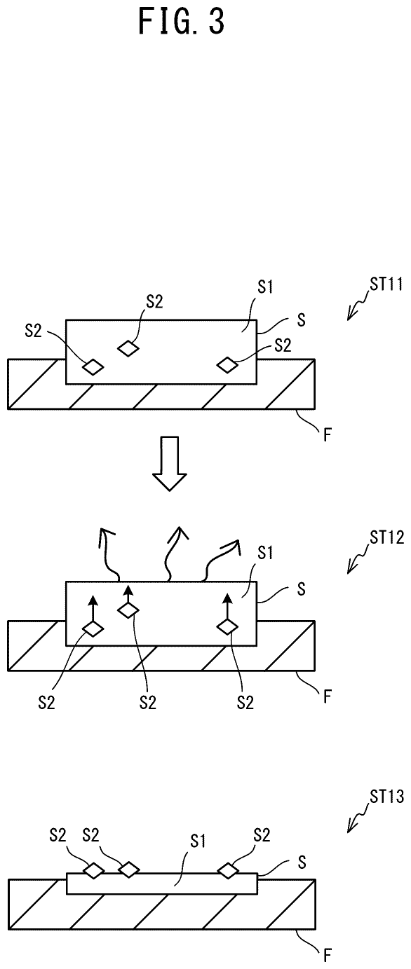

The behavior of a coagulant S2 in the drying processing will be described with reference to FIG. 3. As shown in a state ST11, before the drying processing, a pre-treatment liquid S has been applied to the fabric F by the application processing. In this state, a concentration of the coagulant S2 in the upper half of the pre-treatment liquid S is similar to a concentration of the coagulant S2 in the lower half of the pre-treatment liquid S.

As shown in a state ST12, during the drying processing, a solvent component S1 in the pre-treatment liquid S evaporates and the coagulant S2 moves upward through the solvent component S1. As a result, as shown in a state ST13, subsequent to the drying processing, the coagulant S2 becomes concentrated in the upper portion of the pre-treatment liquid S at the surface of the fabric F. In other words, subsequent to the drying processing, the concentration of the coagulant S2 in the upper half of the pre-treatment liquid S becomes higher than the concentration of the coagulant S2 in the lower half of the pre-treatment liquid S.

As a result, when the subsequent print processing and post-processing are performed, the white ink is coagulated more easily by the coagulant S2 at the surface of the fabric F. Thus, the drying processing contributes to the vivid color development of the white ink.

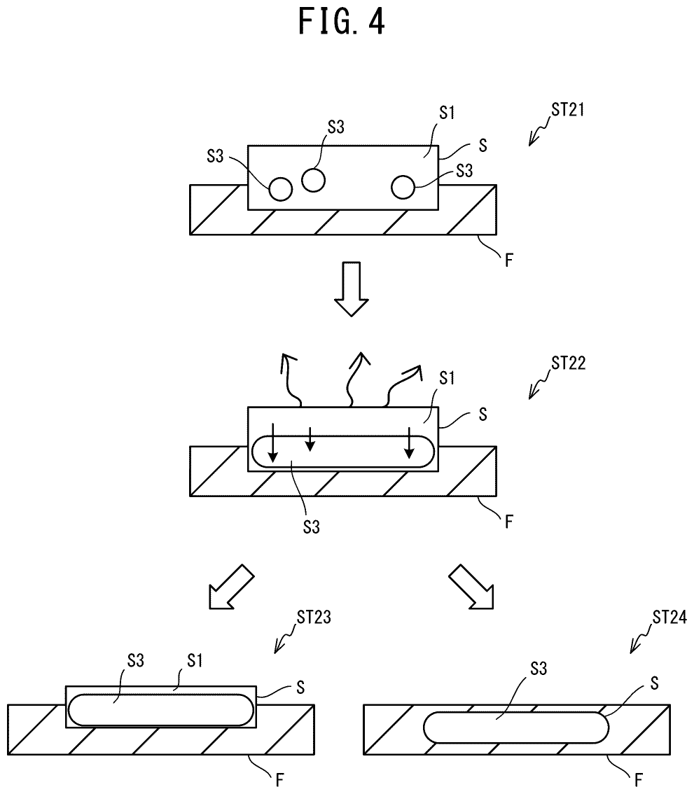

The behavior of a resin component S3 in the drying processing will be described with reference to FIG. 4. As shown in a state ST21, prior to the drying processing, the pre-treatment liquid S has been applied to the fabric F by the application processing. As shown in a state ST22, during the drying processing, the solvent component S1 in the pre-treatment liquid S evaporates. In this case, a movement amount of the resin component S3 is smaller than a movement amount of the coagulant S2 shown in FIG. 3.

Thus, as shown in a state ST23, when an evaporation amount of the solvent component S1 in the drying process is a constant amount, the resin component S3 more easily remains on the surface of the fabric F, and more easily forms a membrane. In this case, when the subsequent print processing and post-processing are performed, permeation of the white ink into the fabric F is suppressed by the resin component S3 that has formed the membrane on the surface of the fabric F. Thus, when the evaporation amount of the solvent component S1 is the constant amount, the drying processing contributes to the vivid color development of the white ink, compared to when the evaporation amount of the solvent component S1 exceeds the constant amount.

As shown in a state ST24, when the evaporation amount of the solvent component S1 exceeds the constant amount during the drying processing, the resin component S3 more easily becomes soft. When the resin component S3 becomes soft, the resin component S3 more easily permeates the fabric F. As a result, when the subsequent print processing and post-processing are performed, the permeation of the white ink into the fabric F is less likely to be suppressed by the resin component S3. Thus, when the evaporation amount of the solvent component S1 exceeds the constant amount, surface fibers of the fabric F are more likely to be exposed from the white ink applied to the fabric F, compared to when the evaporation amount of the solvent component S1 is the constant amount. Therefore, when the evaporation amount of the solvent component S1 exceeds the constant amount, the drying processing is less likely to contribute to the vivid color development of the white ink, compared to when the evaporation amount of the solvent component S1 is the constant amount.

In the present embodiment, the evaporation amount of the solvent component S1 being the constant amount means that a degree of the solvent component S1 remains in a minute amount. A degree of the solvent component S1 remaining in a minute amount refers to the fact that a target dryness factor to be described later is within a range of 85% to 95%. In the present disclosure, the expression “parameter P is within a range of value X to value Y” means that parameter P is greater than or equal to value X and less than or equal to value Y. When the evaporation amount of the solvent component S1 exceeds the constant amount, this refers to a degree at which substantially all of the solvent component S1 evaporates. The degree at which substantially all of the solvent component S1 evaporates refers to a degree at which the target dryness factor exceeds 95%.

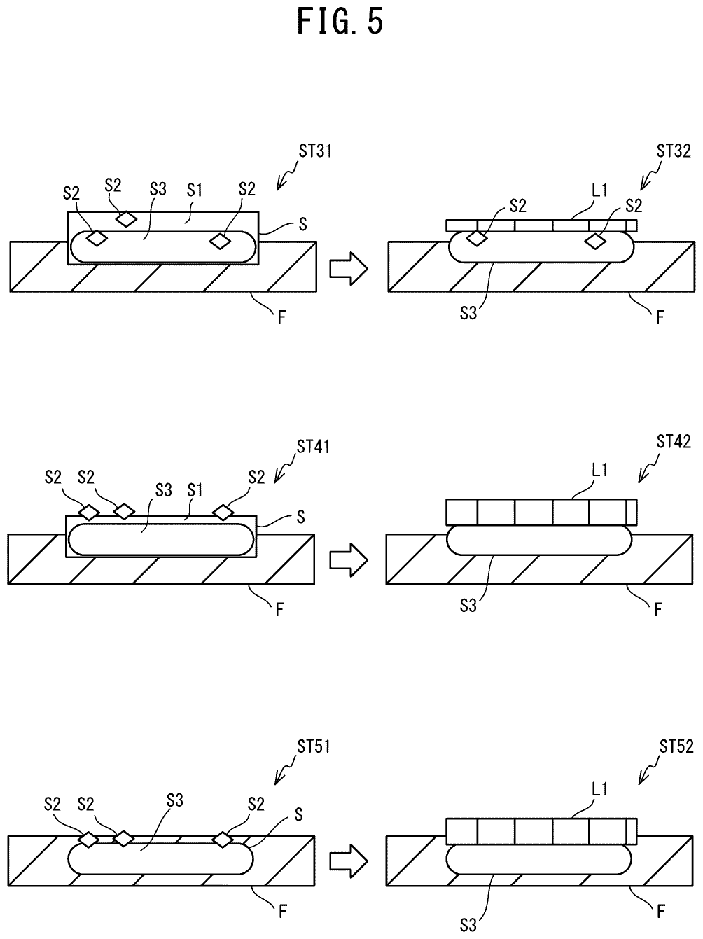

An impact of the evaporation amount of the solvent component S1 on the color development performance of the white ink in the drying processing will be described with reference to FIG. 5. A state ST31 indicates a case in which the evaporation amount of the solvent component S1 in the drying processing does not reach the constant amount. Thus, in the state ST31, the coagulant S2 is not concentrated in the upper portion of the pre-treatment liquid S.

In this case, when the subsequent print processing is performed, the white ink is not easily coagulated. Thus, as shown in a state ST32, a white ink layer L1 is thinner than in a state ST42 and in a state ST52 to be described later. Thus, the color development performance of the white ink deteriorates, compared to that in the state ST42 and the state ST52.

A state ST41 indicates the case in which the evaporation mount of the solvent component S1 is the constant amount in the drying processing. Thus, in the state ST41, the coagulant S2 is concentrated in the upper portion of the pre-treatment liquid S, and the resin component S3 is formed as the membrane on the surface of the fabric F.

In this case, when the subsequent print processing is performed, the white ink is easily coagulated. Thus, as shown in the state ST42, the thickness of the white ink layer L1 is greater than that in the state ST32. Furthermore, the white ink layer L1 is suppressed from permeating into the fabric F by the resin component S3. Thus, the color development performance of the white ink is improved compared to that in the state ST32.

A state ST51 indicates the case in which the evaporation amount of the solvent component S1 exceeds the constant amount in the drying processing. Thus, in the state ST51, the coagulant S2 is concentrated in the upper portion of the pre-treatment liquid S and the resin component S3 permeates into the fabric F.

In this case, when the subsequent print processing is performed, the white ink is easily coagulated. Thus, as shown in the state ST52, the thickness of the white ink layer L1 is greater than that in the state ST32. However, the effect of the resin component S3 in suppressing the permeation of the white ink layer L1 into the fabric F is reduced compared to the state ST42, and the white ink layer L1 therefore sinks into the fabric F. Thus, the surface fibers of the fabric F are likely to be exposed from the white ink layer L1. As a result, although the color development performance of the white ink improves compared to that in the state ST32, it deteriorates compared to the color development performance of the white ink in the state ST42.

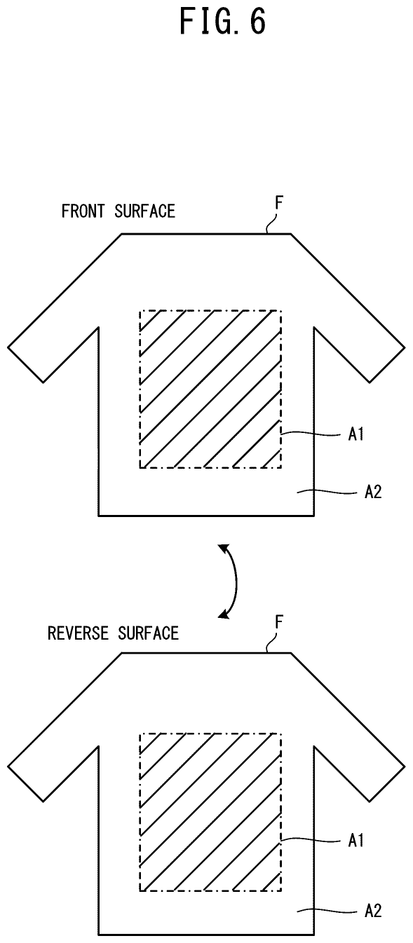

An application region A1 and a non-application region A2 will be defined with reference to FIG. 6. The application region A1 is a region of the fabric F to which the pre-treatment liquid is applied by the application processing. The non-application region A2 is a region of the fabric F other than the application region A1. In other words, the non-application region A2 is the region of the fabric F to which the pre-treatment liquid is not applied by the application processing.

When the fabric F has a tubular shape, as with a T-shirt, the non-application region A2 is the region to which the pre-treatment liquid is not applied by the application processing, of an outer peripheral surface of the fabric F. For example, the front surface of the fabric F is the surface facing the application portion 31 in the application processing. The front surface of the fabric F is not a reverse surface of the fabric F. If the fabric F is a T-shirt, the front surface of the fabric F does not contact the skin. The reverse surface of the fabric F is, for example, a surface on the opposite side from the front surface, of the outer peripheral surface of the fabric F.

The pre-treatment liquid is applied to the front surface of the fabric F by the application portion 31. Thus, the application region A1 is included in the front surface of the fabric F.

The pre-treatment liquid applied to the front surface of the fabric F may permeate through to the reverse surface of the fabric F. In this case, the region of the reverse surface of the fabric F into which the pre-treatment liquid has permeated also corresponds to the application region A1. Thus, the application region A1 also includes a portion of the reverse surface of the fabric F. A size of the application region A1 in the front surface of the fabric F and a size of the application region A1 in the reverse surface of the fabric F may be the same as each other, or may differ from each other.

In the present embodiment, the fabric F being wetted by the permeation of the pre-treatment liquid also refers to the pre-treatment liquid being applied to the fabric F.

The target dryness factor will be defined. In the following description, a weight of the moisture contained in the application region A1 of the fabric F at a time point preceding the application of the pre-treatment liquid to the fabric F will be referred to as an “initial moisture weight of the application region A1”. In the present embodiment, the time point preceding the application of the pre-treatment liquid to the fabric F indicates a time point preceding the application processing. The initial moisture weight of the application region A1 indicates a weight of moisture absorbed in advance from the air by the application region A1 of the fabric F.

A weight of the solvent component contained in the pre-treatment liquid applied to the fabric F at a time point subsequent to the application processing and preceding the drying processing will be referred to as an “initial solvent weight”. In the present embodiment, the time point preceding the drying processing indicates a time point preceding the primary drying processing. When the pre-treatment liquid contains an additive corresponding to the solvent component, the weight of the additive corresponding to the solvent component is also included in the weight of the solvent component.

A weight indicating a total of the initial solvent weight and the initial moisture weight of the application region A1 will be referred to as a “weight of a target liquid”. An amount by which the weight of the application region A1 of the fabric F changes due to the drying processing will be referred to as a “target change amount of the application region A1”. The target change amount of the application region A1 indicates an amount obtained by subtracting the weight of the application region A1 at an end point of the secondary drying processing from the weight of the application region A1 at a start point of the primary drying processing.

The target dryness factor indicates a ratio of the target change amount of the application region A1 to the weight of the target liquid. Thus, the target dryness factor can be expressed by the following Equation 1.

$$Target dryness factor = target change amount \\ of application region A 1 / weight of target liquid \qquad ( Equation 1 )$$

In the following description, an amount by which the weight of the entire fabric F changes due to the drying processing will be referred to as a “target change amount of the fabric F”. The weight of the entire fabric F at the start point of the primary drying processing will be referred to as a “post-application weight of the fabric F”. The weight of the entire fabric F at the end point of the second drying processing will be referred to as a “post-secondary drying processing weight of the fabric F”. The target change amount of the fabric F indicates an amount obtained by subtracting the post-secondary drying processing weight of the fabric F from the post-application weight of the fabric F. Thus, the target change amount of the fabric F can be expressed by the following Equation 2.

$$Target change amount of fabric F = post - application weight of fabric F - post - secondary drying processing weight of fabric F \qquad ( Equation 2 )$$

The target change amount of the application region A1 matches an amount obtained by subtracting an initial moisture weight of the non-application region A2 from the target change amount of the fabric F. Thus, Equation 1 is modified to the following Equation 3.

$$Target dryness factor = ( target change amount of fabric F - initial moisture weight of non - application region A 2 ) / \\ ( initial solvent weight + initial moisture weight of application region A 1 ) \qquad ( Equation 3 )$$

A primary dryness factor will be defined. An amount by which the weight of the application region A1 of the fabric F changes due to the primary drying processing will be referred to as a “primary change amount of the application region A1”. The primary change amount of the application region A1 indicates an amount obtained by subtracting the weight of the application region A1 at an end point of the primary drying processing from the weight of the application region A1 at the start point of the primary drying processing.

The primary dryness factor indicates a ratio of the primary change amount of the application region A1 to the weight of the target liquid. Thus, the primary dryness factor can be expressed by the following Equation 4.

$$Primary dryness factor = primary change amount \\ of application region A 1 / weight of target liquid \qquad ( Equation 4 )$$

In the following description, an amount by which the weight of the entire fabric F changes due to the primary drying processing will be referred to as a “primary change amount of the fabric F”. The weight of the entire fabric F at the end point of the primary drying processing will be referred to as a “post-primary drying processing weight of the fabric F”. The primary change amount of the fabric F indicates an amount obtained by subtracting the post-primary drying processing weight of the fabric F from the post-application weight of the fabric F. Thus, the primary change amount of the fabric F can be expressed by the following Equation 5.

$$Primary change amount of fabric F = post - application weight of fabric F - post - primary drying processing weight of fabric F \qquad ( Equation 5 )$$

The weight of the moisture contained in the non-application region A2 of the fabric F at a time point preceding the application of the pre-treatment liquid to the fabric F will be referred to as the “initial moisture weight of the non-application region A2”. The initial moisture weight of the non-application region A2 indicates a weight of moisture absorbed in advance from the air by the non-application region A2 of the fabric F.

The primary change amount of the application region A1 matches an amount obtained by subtracting the initial moisture weight of the non-application region A2 from the primary change amount of the fabric F. Thus, the primary dryness factor can be expressed by the following Equation 6, which is modified from Equation 4.

$$Primary dryness factor = ( primary change amount of fabric F - initial moisture weight of non - application region A 2 ) / \\ ( initial solvent weight + initial moisture weight of application region A 1 ) \qquad ( Equation 6 )$$

In the following description, an amount by which the weight of the application region A1 of the fabric F changes due to the secondary drying processing will be referred to as a “secondary change amount of the application region A1”. The secondary change amount of the application region A1 indicates an amount obtained by subtracting the weight of the application region A1 at the end point of the secondary drying processing from the weight of the application region A1 at a start point of the secondary drying processing.

In the present embodiment, the target change amount of the application region A1 may not match the amount obtained by adding the primary change amount of the application region A1 and the secondary change amount of the application region A1. The reason for this is that, between the primary drying processing and the secondary drying processing, the fabric F may absorb moisture from the air.

An initial moisture content of the fabric F will be defined. In the following description, the weight of the moisture contained in the entire fabric F at a time point preceding the application of the pre-treatment liquid to the fabric F will be referred to as an “initial moisture weight of the fabric F”. The weight of the fabric F at the time point preceding the application of the pre-treatment liquid to the fabric F will be referred to as an “initial weight of the fabric F”.

The initial weight of the fabric F indicates a total of the weight of the fabric F not containing moisture, and the initial moisture weight of the fabric F. Thus, the weight of the fabric F not containing the moisture matches a weight obtained by subtracting the initial moisture weight of the fabric F from the initial weight of the fabric F. In the following description, the weight of the fabric F not containing the moisture will be referred to as a “post-drying weight of the fabric F”.

The initial moisture content of the fabric F indicates the ratio of the initial moisture weight of the fabric F to the post-drying weight of the fabric F. Thus, the initial moisture content of the fabric F can be expressed by the following Equation 7.

$$Initial moisture content of fabric F = initial moisture weight of fabric F / post - drying weight of fabric F \qquad ( Equation 7 )$$

The post-drying fabric F does not substantially contain any moisture.

The initial moisture weight of the application region A1 is calculated using the following Equation 8, regardless of a size of the fabric F.

$$( Equation 8 )$$

$$Initial moisture weight of application region A 1 = initial weight of fabric F \times initial moisture content of fabric F \times surface area of application region A 1 / surface area of fabric F$$

The initial moisture weight of the non-application region A2 is calculated by the following Equation 9, regardless of the size of the fabric F.

$$( Equation 9 )$$

$$Initial moisture weight of non - application region A 2 = initial weight of fabric F \times initial moisture content of fabric F \times surface area of non - application region A 2 / surface area of fabric F$$

The surface area of the fabric F matches a surface area obtained by adding the surface area of the application region A1 and the surface area of the non-application region A2.

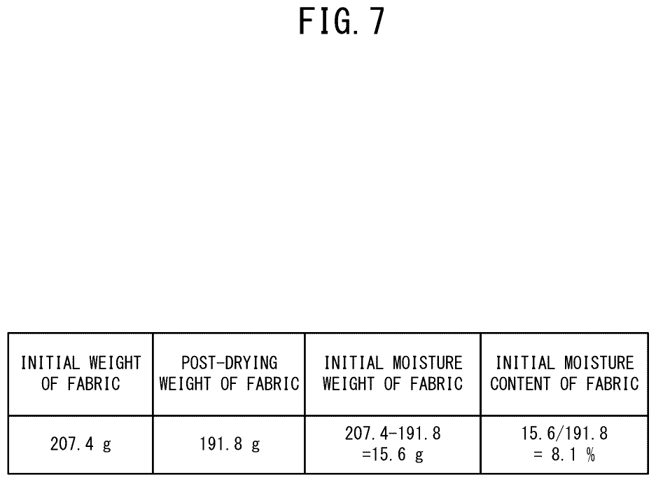

A moisture content measurement experiment for determining the initial moisture content of the fabric F will be described with reference to FIG. 7. The fabric F used in the moisture content measurement experiment will be described. The type of the fabric F is the same as the type of the fabric F used in a dryness factor measurement experiment to be described below.

First, the initial weight of the fabric F is measured. In the example shown in FIG. 7, the initial weight of the fabric Fis 207.4 g. Next, the fabric F is dried in the oven until the weight of the fabric F no longer substantially changes. One example of the oven is the gas-fired oven 4A. For example, when the size of the fabric F is 50 cm square, the fabric F is preferably dried in the gas-fired oven 4A for approximately 120 seconds at 160° C.

The post-drying weight of the fabric F is measured. In the example shown in FIG. 7, the post-drying weight of the fabric Fis 191.8 g. The weight obtained by subtracting the post-drying weight of the fabric F from the initial weight of the fabric F matches the initial moisture weight of the fabric F. Thus, in the example shown in FIG. 7, the initial moisture weight of the fabric F is calculated as follows.

$$The initial moisture weight of the fabric F = 207.4 - 191.8 = 15.6 g$$

In this way, the above-described Equation 7 is used to calculate the initial moisture content of the fabric F as follows.

$$Initial moisutre content of fabric F = 15.6 / 191.8 = 8.1 \%$$

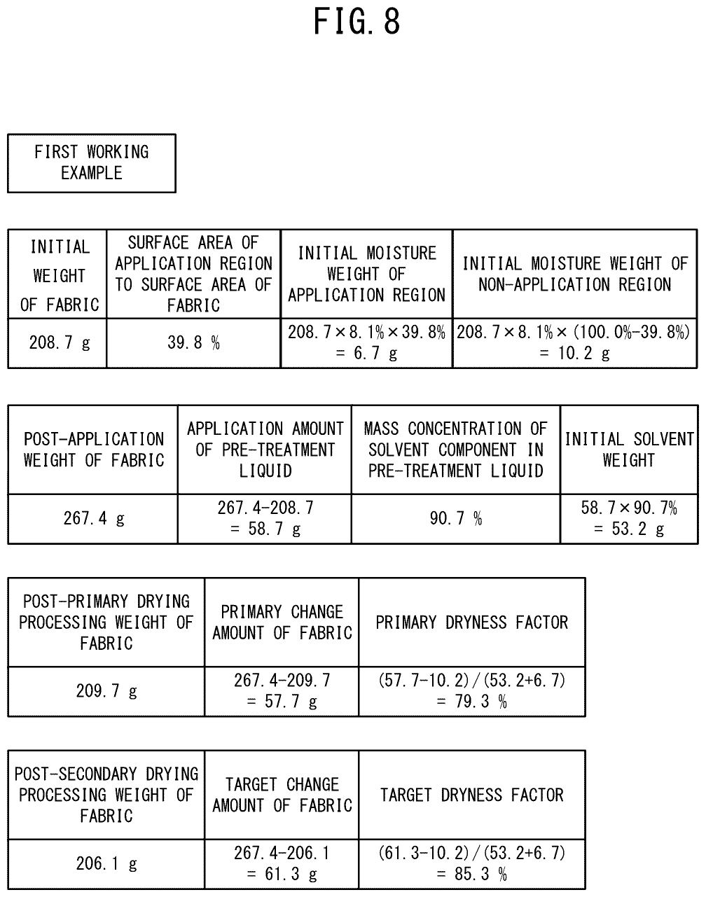

The dryness factor measurement experiment for determining the primary dryness factor and the target dryness factor will be described with reference to FIG. 8. The dryness factor measurement experiment is preferably performed on the same day as the moisture content measurement experiment. In this case, the atmospheric temperature and humidity at the experiment site are the same for the moisture content measurement experiment and the dryness factor measurement experiment. Thus, it can be assumed that the initial moisture content is substantially the same for the fabric F used in the moisture content measurement experiment and for the fabric F used in the dryness factor measurement experiment. In the dryness factor measurement experiment, the application processing, the primary drying processing, and the secondary drying processing are performed on the fabric F in the order of the application processing, the primary drying processing, and the secondary drying processing.

The composition of the pre-treatment liquid used in the dryness factor measurement experiment will be described. The pre-treatment liquid contains the polyvalent metal salt, the resin component, the solvent component, the surfactant, and the antifungal agent. The pre-treatment liquid contains 18 wt % calcium nitrate tetrahydrate as the polyvalent metal salt. The pre-treatment liquid contains 6.8 wt % water-based resin as the resin component. The water-based resin is Mowinyl 6941.

The pre-treatment liquid contains water and an organic solvent as the solvent component. The pre-treatment liquid contains 15 wt % diglycerine as the organic solvent. The pre-treatment liquid contains 0.8 wt % Olfine EXP4123 as the surfactant. The pre-treatment liquid contains 0.03 wt % Proxel GXL(S) as the antifungal agent. Proxel is a registered trademark of Arch UK Biocides Limited.

The mass percent of the water is the remaining content of the pre-treatment liquid other than the polyvalent metal salt, the resin component, the organic solvent, the surfactant, and the antifungal agent. The dilution ratio with the water is ×3 vol %. In other words, the dilution ratio with water is 3 times on a volume basis.

Apparatus used for the dryness factor measurement experiment will be described. The Cube2 manufactured by PRINT SYSTEM Co. Ltd. was used as the application device 3A. PRO-CURE manufactured by ADELCO, and the Drawer Drying Cabinet DDC-3A manufactured by Adelco Screen Process Ltd. were used as the gas-fired oven 4A. Hotronix Air Fusion IQ manufactured by STAHLS' Inc. was used as the heat press device 5A. Hotronix and Fusion IQ are registered trademarks of STAHLS' Inc.

Hereinafter, a method of determining the primary dryness factor and the target dryness factor in a first working example will be described. The primary dryness factor and the target dryness factor for second to eighth working examples, and for first and second comparative examples will also be determined in a similar manner to the first working example. FIG. 8 is based on moisture content measurement results shown in FIG. 7.

First, the weight of the fabric F in the first working example, namely, the initial weight of the fabric F in the first working example, is measured. The fabric F used in the dryness factor measurement experiment is of the same type as the fabric F used in the moisture content measurement experiment, but is a separate fabric F. Thus, the initial weight of the fabric F used in the dryness factor measurement experiment may differ from the initial weight of the fabric F used in the moisture content measurement experiment. The initial weight of the fabric F in each of the second to eighth working examples, and the first and second comparative examples may also differ from the initial weight of the fabric F of the first working example. In the example shown in FIG. 8, the initial weight of the fabric F of the first working example is 208.7 g.

In the example shown in FIG. 8, the proportion of the surface area of the application region A1 to the surface area of the fabric F is 39.8%. In this case, according to Equation 8, the initial moisture weight of the application region A1 of the first working example is calculated as follows using 8.1% as the initial moisture content of the fabric F.

$$Initial moisture weight of application region A 1 of first working example = 208.7 \times 8.1 \% \times 39.8 \% = 6.7 g$$

According to Equation 9, the initial moisture weight of the non-application region A2 of the first working example is calculated as follows, using 8.1% as the initial moisture content of the fabric F.

$$Initial moisture weight of non - application region A 2 of first working example = 208.7 \times 8.1 \% \times ( 100. \% - 39.8 \% ) = 10.2 g$$

Next, the application processing is performed in the application device 3A on the fabric F of the first working example. In the application processing, 42.4 g of the pre-treatment liquid per 14×16 inches was applied to the fabric F.

When the application processing is complete, the weight of the fabric F of the first working example is measured. An application amount of the pre-treatment liquid by the application processing is an amount obtained by subtracting the initial weight of the fabric F from the post-application weight of the fabric F. In the example shown in FIG. 8, the post-application weight of the fabric F of the first working example is 267.4 g. Thus, in the example shown in FIG. 8, the application amount of the pre-treatment liquid by the application processing is calculated as follows.

$$Application amount of pre - treatment liquid of first working example = 267.4 - 208.7 = 58.7 g$$

The initial solvent weight is the amount obtained by multiplying the application amount of the pre-treatment liquid in the application processing by a mass concentration of the solvent component in the pre-treatment liquid. In the example shown in FIG. 8, the mass concentration of the solvent component in the pre-treatment liquid is 90.7%. 90.7% is the ratio of a total weight of the water and diglycerine to the entire weight of the pre-treatment liquid. In the example shown in FIG. 8, the initial solvent weight is calculated as follows.

$$Initial solvent weight of first working example = 58.7 \times 90.7 \% = 53.2 g$$

Next, the primary drying processing is performed in the gas-fired oven 4A on the fabric F of the first working example. When the primary drying processing is complete, the weight of the fabric F of the first working example is measured. In the example shown in FIG. 8, the post-primary drying processing weight of the fabric F of the first working example is 209.7 g.

The primary change amount of the fabric F of the first working example is calculated as follows using Equation 5.

$$Primary change amount of fabric F of first working example = 267.4 - 209.7 = 57.7 g$$

Thus, the primary dryness factor of the first working example is calculated as follows using Equation 6.

$$Primary dryness factor of first working example = ( 57.7 - 10.2 ) / ( 53.2 + 6.7 ) = 79.3 \%$$

Next, the secondary drying processing is performed in the heat press device 5A on the fabric F of the first working example. When the secondary drying processing is complete, the weight of the fabric F of the first working example is measured. In the example shown in FIG. 8, the post-secondary drying processing weight of the fabric F of the first working example is 206.1 g.

The target change amount of the fabric F of the first working example is calculated as follows using Equation 2.

$$Target change amount of fabric F of first working example = 267.4 - 206.1 = 61.3 g$$

Thus, the target dryness factor of the first working example is calculated as follows using Equation 3.

$$Target dryness factor of first working example = ( 61.3 - 10.2 ) / ( 53.2 + 6.7 ) = 85.3 \%$$

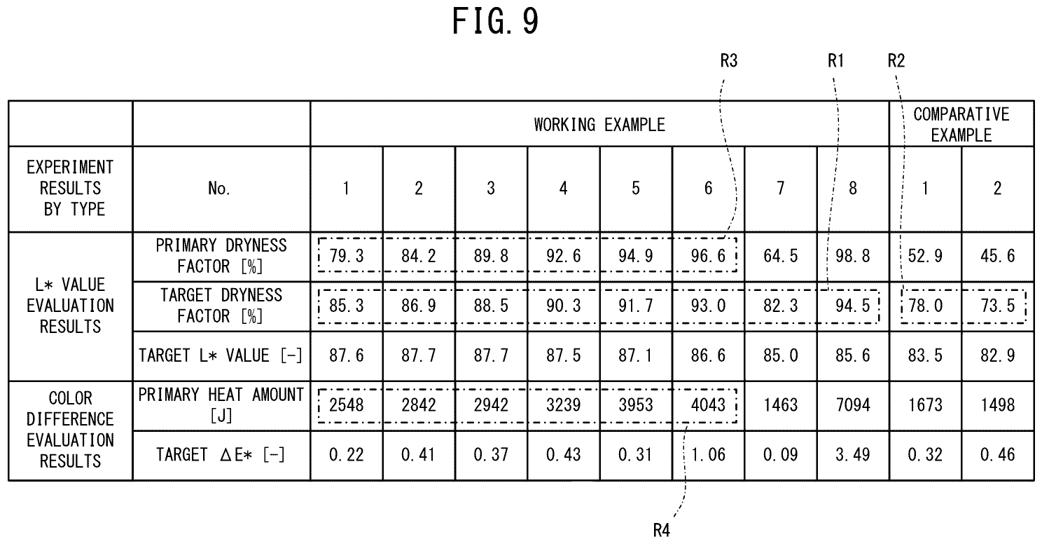

In a similar manner, the primary dryness factor and the target dryness factor are calculated for the second to eighth working examples, and the first and second comparative examples. Calculation results for the primary dryness factor and the target dryness factor for the second to eighth working examples, and the first and second comparative examples are shown in FIG. 9.

Processing conditions for the primary drying processing differ in each of the first to eighth working examples, and the first and second comparative examples. The processing conditions of the primary drying processing include, for example, the heating temperature of the heater 44, or the operating times of the heater 44 and the fan 45. Processing conditions of the secondary drying processing are the same for each of the first to eighth working examples, and the first and second comparative examples. The processing conditions of the secondary drying processing include, for example, the temperature of the heater 52, the pressurizing time by the press portion 51, and the pressurizing magnitude by the press portion 51.

An evaluation experiment was conducted to determine a correlation between the primary dryness factor and a target L* value, and a correlation between the target dryness factor and the target L* value. In an evaluation experiment to evaluate the target L* value, the print processing was performed in the printer 2A for each of the first to eighth working examples, and the first and second comparative examples shown in FIG. 9. In the print processing, the white ink was used.

GCX-4 W manufactured by Brother Industries Ltd. was used as the white ink.

Apparatus used in the evaluation experiment to evaluate the target L* value will be described. The GTX-pro manufactured by Brother Industries Ltd. was used as the printer 2A. The X-Rite exact manufactured by X-Rite Incorporated was used as a colorimeter to measure the target L* value. X-Rite is a registered trademark of X-Rite Incorporated.

The fabric F used in the evaluation experiment to evaluate the target L* value will be described. In this case, the fabric F is black. The fabric Fis 100% cotton. Specifically, the fabric F is GILDAN Ultra Cotton Black manufactured by Gildan Activewear Inc.

The target L* value is the L* value in the L*a*b color space for the white ink layer formed on the fabric F in the print processing. The L* value indicates a degree of whiteness. The higher the L* value, the higher the degree of whiteness.

In the evaluation experiment, in order to evaluate the L* value, with respect to the fabric F on which the print processing had been performed for each of the first to eighth working examples, and the first and second comparative examples, the colorimeter was used to measure the L* value of the white ink layer formed on the fabric F. FIG. 9 shows the results of the measured target L* value for each of the first to eighth working examples, and the first and second comparative examples.

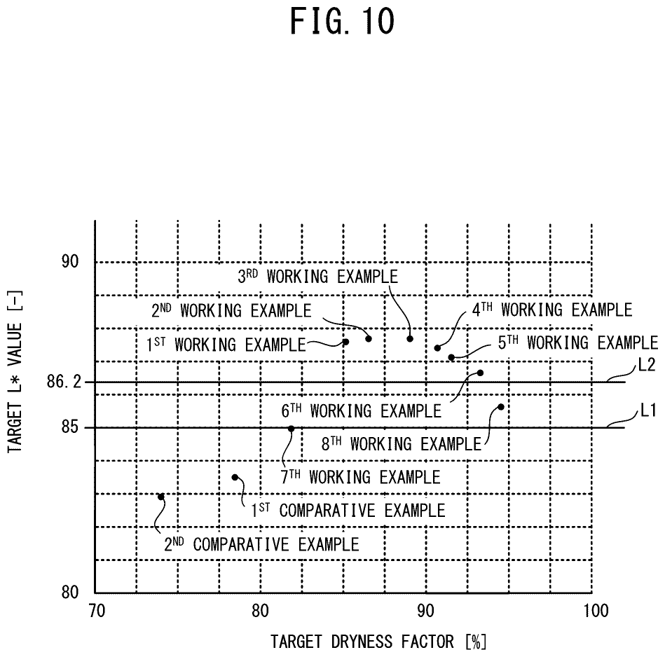

The results of the evaluation experiment for the target L* value will be described with reference to FIG. 9 to FIG. 11. As shown by an enclosure R1 in FIG. 9, the first to eighth working examples are examples in which the target dryness factor is within a range of 82% to 95%, inclusive. In this case, as shown by the enclosure R1 in FIG. 9 and by a line L1 in FIG. 10, the target L* value was equal to or greater than 85 in every example. According to JP 2019-11527 A, the L* value is preferably equal to or greater than 85.

On the other hand, as shown by an enclosure R2 in FIG. 9, the first and second comparative examples are examples in which the target dryness factor does not reach 82%. Specifically, the first and second comparative examples are examples in which the target dryness factor is 78% or less. In this case, as shown by the enclosure R2 in FIG. 9 and by the line L1 in FIG. 10, the target L* value was less than 85 in both examples. More specifically, the target L* value was less than 84 in both examples.

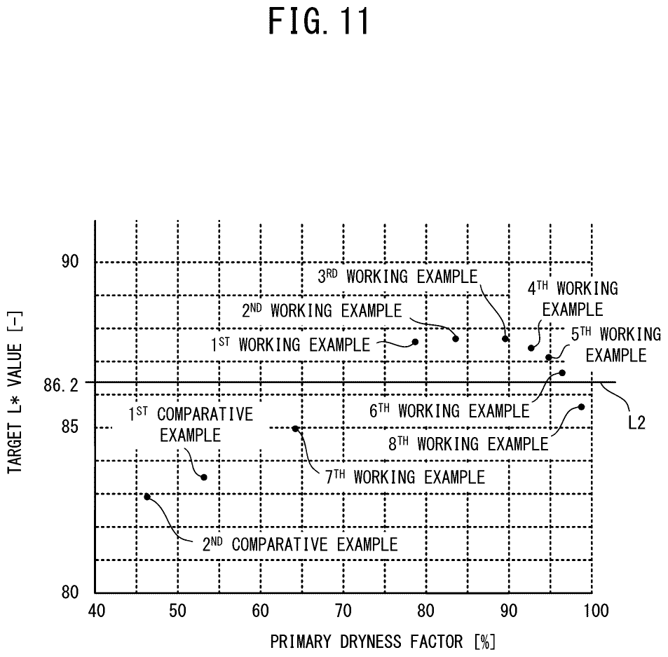

As shown by an enclosure R3 in FIG. 9, the first to sixth working examples are examples in which the primary dryness factor is in a range of 79% to 97%, inclusive. In this case, the target dryness factor is within the range of 85% to 95%. Furthermore, as shown in FIG. 9 and by a line L2 in FIG. 11, the target L* value was equal to or greater than 86.2 in every example.

Generally, when a color difference ΔE*ab is equal to or greater than 1.2, in other words, when the color difference ΔE*ab is greater than a practical color difference a, a difference in hue can be perceived. Specifically, when two colors for which the color difference ΔE*ab is equal to or greater than 1.2 are arranged side by side, nearly all people can easily perceive the color difference. Thus, when the L* value is 85+1.2, namely, is 86.2 or more, compared to when the L* value is 85, it can be said that the color development performance of the white ink is improved to an extent at which nearly all people can easily perceive the color difference. In other words, when the primary dryness factor is contained within the range of 79% to 97%, inclusive, compared to a case in which the primary dryness factor is less than 79% or exceeds 97%, it can be said that the color development performance of the white ink is improved to an extent at which nearly all people can easily perceive the color difference.

An evaluation experiment was conducted to determine a correlation between a primary heat amount and a target color difference ΔE*ab. Apparatus used in the evaluation experiment for the target color difference ΔE*ab will be described. The X-Rite exact manufactured by X-Rite Incorporated was used as the colorimeter to measure the target color difference ΔE*ab.

The fabric F used when evaluating the target color difference ΔE*ab will be described. The fabric Fis white. The fabric Fis 100% cotton. Specifically, the fabric F is GILDAN Ultra Cotton White manufactured by Gildan Activewear Inc.

The target color difference ΔE*ab is the color difference ΔE*ab between the fabric F preceding the primary drying processing, and the fabric F subsequent to the primary drying processing when the primary drying processing is performed. The color difference ΔE*ab indicates the difference in hue. The greater the color difference ΔE*ab, the greater the difference in hue. For example, in JIS Z 8730, the color difference ΔE*ab of 1.2 is established as the practical color difference a. The practical color difference a is a color difference at which the human eye can sense a difference in color.

The target color difference ΔE*ab is calculated using the following Equation 10.

$$Target color difference Δ E * ab = {\{ {( L {*}_{1} - L {*}_{2} )}^{2} + {( a {*}_{1} - a {*}_{2} )}^{2} + {( b {*}_{1} - b {*}_{2} )}^{2} \}}^{1 / 2} \qquad ( Equation 10 )$$

(L*₁, a*₁, b*₁) are colors in the L*a*b color space in the fabric F before the drying processing.

(L*₂, a*₂, b*₂) are colors in the L*a*b color space in the fabric F subsequent to the drying processing.

In the evaluation experiment, in order to evaluate the target color difference ΔE*ab, the colors of the L*a*b color space were measured as follows. For each of the first to eighth working examples, and the first and second comparative examples, the colors of the L*a*b color space of the non-application region A2 of the fabric F before the drying processing were measured using the colorimeter. Then, for each of the first to eighth working examples, and the first and second comparative examples, the colors of the L*a*b color space of the non-application region A2 of the fabric F subsequent to the drying processing were measured using the colorimeter. In this way, using the above-described Equation 10, the target color difference ΔE*ab was calculated. FIG. 9 shows the results of the calculated target color difference ΔE*ab for each of the first to eighth working examples, and the first and second comparative examples.

The primary heat amount is a heat amount received by the fabric F to which the pre-treatment liquid has been applied, from the gas-fired oven 4A in the primary drying processing. For example, a method of determining the primary heat amount of the first working example will be described. The primary drying processing is performed in the gas-fired oven 4A on water, in place of the fabric F, under the same conditions as the processing conditions of the primary drying processing of the first working example.

Based on a weight change amount of the water due to the primary drying processing, the primary heat amount is calculated using the following Equation 11.

$$Primary heat amount = m \times c \times ( T 2 - T 1 ) + m \times L \qquad ( Equation 11 )$$

m is the weight change amount of the water (g).

c is the specific heat capacity (J/g·K) of water.

The specific heat capacity of water is 4.18 J/g. K.

T1 is the room temperature (° C.).

For example, when the temperature of the atmosphere in the room in which the experiment was conducted is 25° C., the room temperature is 25° C.

T2 is the temperature (C) of the atmosphere inside the gas-fired oven 4A in the primary drying processing.

The temperature of the liquid is assumed not to exceed 100° C., and when T2 exceeds 100° C., T2 is assumed as 100° C.

L is the heat of vaporization of water (J/g).

The heat of vaporization of water is 2260 J/g.

FIG. 9 shows results of the calculated primary heat amount for each of the first to eighth working examples, and the first and second comparative examples.

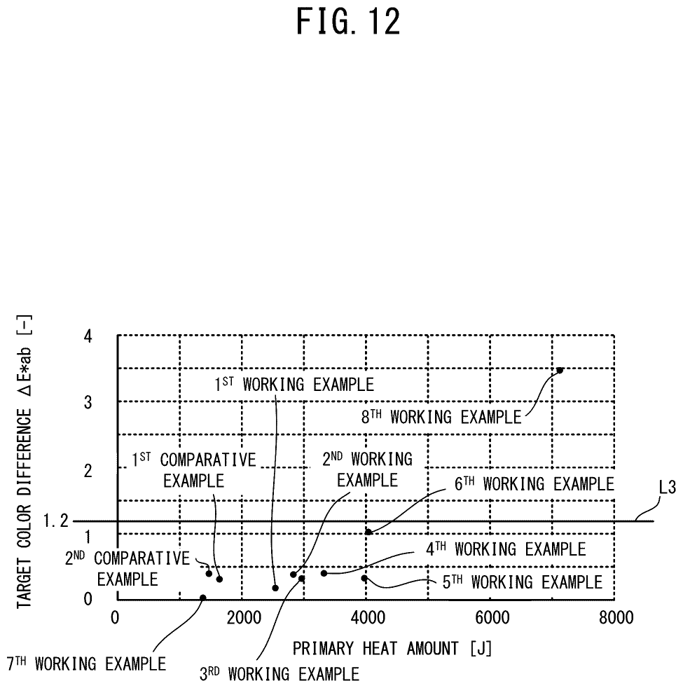

The results of the evaluation experiment for the target color difference ΔE*ab will be described with reference to FIG. 9 and FIG. 12. As shown by an enclosure R4 in FIG. 9, the first to sixth working examples are examples in which the primary heat amount is within a range of 2500 J to 4100 J, inclusive. In this case, as shown by the enclosure R4 in FIG. 9 and by a line L3 in FIG. 12, the target color difference ΔE*ab was less than 1.2 in every example.

Generally, when the color difference ΔE*ab is less than 1.2, in other words, when the color difference ΔE*ab is less than the practical color difference a, the difference in hue cannot be perceived. Specifically, when the color difference ΔE*ab is less than 1.2, the difference is determined to be within a range of tolerance in terms of being sensed by the human eye. In other words, when the primary heat amount is within the range of 2500 J to 4100 J, inclusive, the change in the color of the fabric F due to the drying processing is considered tolerable.

The main processing will be described with reference to FIG. 13. When the power source of the drying device 9 is turned on, the CPU 91 performs the main processing by reading out the control program from the flash memory 92, and operating the control program. In the main processing, the CPU 91 performs control of the primary drying processing and the secondary drying processing.

The CPU 91 determines whether the platen 10 has reached one of the gas-fired ovens 4A to 4D based on position sensors (not shown in the drawings) of the gas-fired ovens 4A to 4D (S11). For example, when the platen 10 has reached the gas-fired oven 4A, the position sensor of the gas-fired oven 4A detects the platen 10 that has arrived. The position sensor of the gas-fired oven 4A outputs information indicating the detected platen 10 to the CPU 91. When the platen 10 has not reached any of the gas-fired ovens 4A to 4D (no at S11), the CPU 91 proceeds to a determination at S21.

When the platen 10 has reached any one of the gas-fired ovens 4A to 4D (yes at S11), the CPU 91 starts the primary drying processing in the gas-fired oven that the platen 10 has reached (S12). Hereinafter, a case will be described in which the platen 10 has reached the gas-fired oven 4A. In this case, in the processing at S12, the CPU 91 starts the operation of the gas-fired burner 441 and the fan motor 451, which are shown in FIG. 2.

The CPU 91 determines whether the primary heat amount is within the range of 2500 J to 4100 J, inclusive (S13). In the present embodiment, when the primary heat amount is within the range of 2500 J to 4100 J, inclusive, the primary dryness factor is within the range of 79% to 97%, inclusive. Thus, in the processing at S13, the CPU 91 may determine whether the primary dryness factor is within the range of 79% to 97%, inclusive.

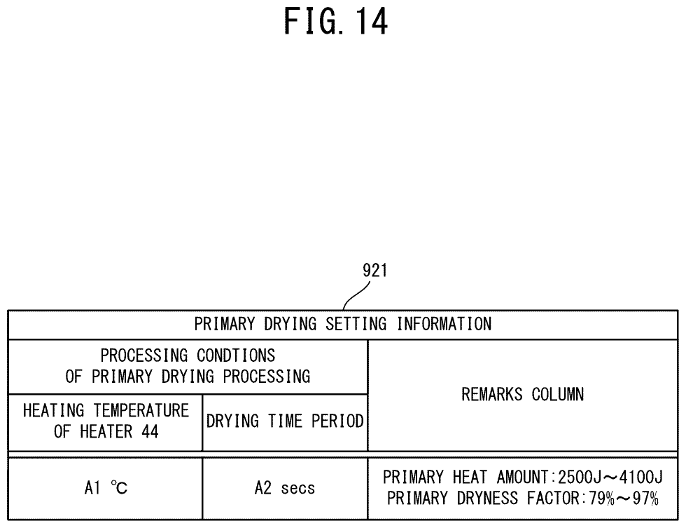

An example of a determination method in the processing at S13 will be described. In the processing at S13, the CPU 91 refers to primary drying setting information 921 shown in FIG. 14.

As shown in FIG. 14, the primary drying setting information 921 indicates the processing conditions of the primary drying processing. The primary drying setting information 921 is configured such that, when the primary drying processing is performed under the processing conditions indicated by the primary drying setting information 921, the primary heat amount is within the range of 2500 J to 4100 J, inclusive. In other words, the primary drying setting information 921 is configured such that, when the primary drying processing is performed under the processing conditions indicated by the primary drying setting information 921, the primary dryness factor is within the range of 79% to 97%, inclusive. The primary drying setting information 921 is determined based on the conditions of the primary drying processing on the above-described first to sixth working examples, for example.

In the present embodiment, the processing conditions of the primary drying processing include the heating temperature of the heater 44 and a drying time period. “A1° C.” is determined as the heating temperature of the heater 44 in the primary drying setting information 921. “A2 secs” is determined as the drying time period in the primary drying setting information 921. Thus, when the primary drying processing is performed for the period “A2 secs” at “A1° C.”, the primary heat amount is within the range of 2500 J to 4100 J, inclusive, and the primary dryness factor is within the range of 79% to 97%, inclusive.

In the processing at S13, based on the primary drying setting information 921, the CPU 91 determines whether the primary drying processing has been performed for the drying time period “A2 secs” at the heating temperature “A1° C.” of the heater 44. When the primary drying processing has been performed for the drying time period “A2 secs” at the heating temperature “A1° C.” of the heater 44, the CPU 91 determines that the primary heat amount is within the range of 2500 J to 4100 J, inclusive. When the primary drying processing has been performed for the drying time period “A2 secs” at the heating temperature “A1° C.” of the heater 44, the CPU 91 determines that the primary dryness factor is within the range of 79% to 97%, inclusive.

When the primary drying processing has not been performed for the drying time period “A2 secs” at the heating temperature “A1° C.” of the heater 44, the CPU 91 determines that the primary heat amount has not reached 2500 J. When the primary drying processing has not been performed for the drying time period “A2 secs” at the heating temperature “A1° C.” of the heater 44, the CPU 91 determines that the primary dryness factor has not reached 79%.

When multiple types of the fabric F are available, the application amount of the pre-treatment liquid to the fabric F by the application processing may differ depending on the type of the fabric F. The heating temperature and the drying time period may be determined in advance in accordance with the application amount of the pre-treatment liquid, namely, in accordance with the type of the fabric F. For example, multiple sets of the primary drying setting information 921 may be stored in the flash memory 92 corresponding to each of the types of the fabric F. In this case, the CPU 91 may acquire the type of the fabric F, and may refer to the primary drying setting information 921 in accordance with the acquired type of the fabric F. For example, the CPU 91 may acquire the type of the fabric F or the application amount of the pre-treatment liquid from a CPU of the application device 3A.

As shown in FIG. 13, the CPU 91 repeats the determination at S13 when the primary heat amount has not reached 2500 J (no at S13). In the processing at S13, the CPU 91 may repeat the determination at S13 when the primary dryness factor has not reached 79% (no at S13).

The CPU 91 ends the primary drying processing (S14) when the primary heat amount is within the range of 2500 J to 4100 J, inclusive (yes at S13). In the processing at S13, CPU 91 may end the primary drying processing (S14) when the primary dryness factor is within the range of 79% to 97%, inclusive (yes at S13). The CPU 91 proceeds to the determination at S21.

The fabric F for which the primary dryness factor is within the range of 79% to 97%, inclusive, as a result of the processing at S14 is conveyed by the conveyance device 7 to one of the heat press devices 5A or 5B.

Based on position sensors (not shown in the drawings) of the heat press devices 5A and 5B, the CPU 91 determines whether the platen 10 has reached one of the heat press devices 5A or 5B (S21). For example, when the platen 10 has reached the heat press device 5A, the position sensor of the heat press device 5A detects the platen 10 that has arrived. The position sensor of the heat press device 5A outputs information indicating the detected platen 10 to the CPU 91. When the platen 10 has reached neither heat press device 5A nor heat press device 5B (no at S21), the CPU 91 returns to the determination at S11.

When the platen 10 has reached one of the heat press devices 5A or 5B (yes at S21), the CPU 91 starts the secondary drying processing in the heat press device that the platen 10 has reached (S22). Hereinafter, a case will be described in which the platen 10 has reached the heat press device 5A. In this case, in the processing at S22, the CPU 91 starts the operation of the heating resistor 521 and the pressure control valve 511, which are shown in FIG. 2.

The CPU 91 determines whether the target dryness factor is within the range of 82% to 95%, inclusive (S23).

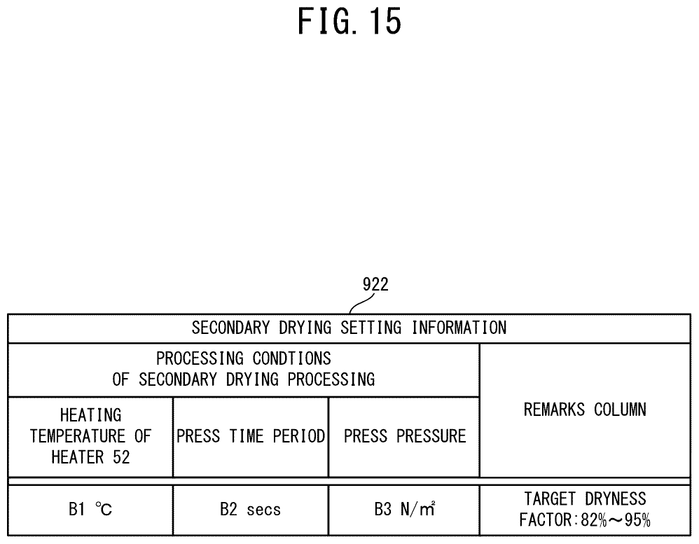

An example of a determination method in the processing at S23 will be described. In the processing at S23, the CPU 91 refers to secondary drying setting information 922 shown in FIG. 15.

As shown in FIG. 15, the secondary drying setting information 922 indicates the processing conditions of the secondary drying processing. The secondary drying setting information 922 is configured such that, when the secondary drying processing is performed under the processing conditions indicated by the secondary drying setting information 922, the target dryness factor is within the range of 82% to 95%, inclusive. The secondary drying setting information 922 is determined based on the conditions of the secondary drying processing on the above-described first to eighth working examples, for example.

In the present embodiment, the processing conditions of the secondary drying processing include the heating temperature of the heater 52, a press time period, and a press pressure. “B1° C.” is determined as the heating temperature of the heater 52 in the secondary drying setting information 922. “B2 secs” is determined as the press time period in the secondary drying setting information 922. “B3 N/m²” is determined as the press pressure in the secondary drying setting information 922. Thus, when the secondary drying processing is performed for the period “B2 secs” at “B1° C.” and “B3 N/m²”, the target dryness factor is within the range of 82% to 95%, inclusive.

In the processing at S23, based on the secondary drying setting information 922, the CPU 91 determines whether the secondary drying processing has been performed for the press time period “B2 secs” at the heating temperature “B1° C.” of the heater 52 and the press pressure “B3 N/m²” of the press portion 51. When the secondary drying processing has been performed for the press time period “B2 secs” at the heating temperature “B1° C.” of the heater 52 and the press pressure “B3 N/m²” of the press portion 51, the CPU 91 determines that the target dryness factor is within the range of 82% to 95%, inclusive. When the secondary drying processing has not been performed for the press time period “B2 secs” at the heating temperature “B1° C.” of the heater 52 and the press pressure “B3 N/m²” of the press portion 51, the CPU 91 determines that the target dryness factor has not reached 82%.

As shown in FIG. 13, when the target dryness factor has not reached 82% (no at S23), the CPU 91 may repeat the determination at S23. When the target dryness factor is within the range of 82% to 95%, inclusive (yes at S23), the CPU 91 ends the secondary drying processing (S24). The CPU 91 returns to the determination at S11.

Main operations and effects of the present embodiment will be described. According to the evaluation experiment results, when the target dryness factor is within the range of 82% to 95%, inclusive, the target L* value is equal to or greater than 85. In the present embodiment, the CPU 91 controls the gas-fired oven 4A and the heat press device 5A to dry the fabric F to which the pre-treatment liquid has been applied until the target dryness factor is within the range of 82% to 95%, inclusive.

According to this configuration, the fabric F is conveyed to a print process in a state in which the target dryness factor is within the range of 82% to 95%, inclusive. Thus, when the white ink has been applied to the fabric F in the print process, the target L* value is equal to or greater than 85. As a result, the drying device 9 contributes to improving the color development of the printed image.

The CPU 91 controls the gas-fired oven 4A in the primary drying processing to dry the fabric F to which the pre-treatment liquid has been applied (S12, S14). Following the primary drying processing, the CPU 91 controls the heat press device 5A to dry the fabric F to which the pre-treatment liquid has been applied until the target dryness factor is within the range of 82% to 95%, inclusive (S22, S24).

According to this configuration, before the secondary drying processing, the fabric F is dried by the primary drying processing. Thus, compared to a case in which the primary drying processing is not performed, an amount by which the fabric F is dried in the secondary drying processing is reduced. Thus, the drying device 9 contributes to facilitating control to cause the target dryness factor to be within the range of 82% to 95%, inclusive.

When the fabric F is removed from the heat press device 5A, the pressing by the press portion 51 in the heat press device 5A is released. Thus, it is difficult to continuously dry multiple fabrics F in the heat press device 5A. On the other hand, the gas-fired oven 4A allows continuous insertion and removal of the fabric F. Thus, the gas-fired oven 4A improves the production efficiency more than the heat press device 5A.

The CPU 91 controls the gas-fired oven 4A in the primary drying processing to dry the fabric F to which the pre-treatment liquid has been applied (S12, S14). In the secondary drying processing, the CPU 91 controls the heat press device 5A to dry the fabric F to which the pre-treatment liquid has been applied (S22, S24).

According to this configuration, the drying device 9 dries the fabric F using the non-contact method, which has the higher production efficiency than the contact method, and then dries the fabric F using the contact method, which causes the surface fibers of the fabric F to be flattened. When the printing is performed in the state in which the surface fibers of the fabric F have been flattened, compared to a case in which the printing is performed in a state in which the surface fibers of the fabric F are raised, the quality of the printed image is improved. Thus, the drying device 9 contributes to improving the quality of the printed image while improving the production efficiency.

According to the evaluation experiment results, when the primary dryness factor is within the range of 79% to 97%, inclusive, and subsequently the target dryness factor is within the range of 82% to 95%, inclusive, the target L* value is equal to or greater than 86.2. In the present embodiment, in the primary drying processing, the CPU 91 controls the drying of the fabric F to which the pre-treatment liquid has been applied until the primary dryness factor is within the range of 79% to 97%, inclusive (S12, S14).

According to this configuration, the drying device 9 facilitates the control to cause the target dryness factor to be closer to a median value of the range of 82% to 95%, inclusive. For example, the target dryness factor is more likely to be within a range of 85% to 93%. Thus, when the white ink has been applied to the fabric F in the print process, the target L* value is more likely to be equal to or greater than 86.2. Thus, the drying device 9 contributes to further improving the color development of the printed image.

According to the evaluation experiment results, when the primary heat amount is within the range of 2500 J to 4100 J, inclusive, the target color difference ΔE*ab is equal to or less than 1.2. In the present embodiment, in the primary drying processing, the CPU 91 operates the gas-fired oven 4A until the primary heat amount is within the range of 2500 J to 4100 J, inclusive (S12, S14).

According to this configuration, the fabric F for which the color difference ΔE*ab is equal to or less than 1.2 is conveyed to the secondary drying processing and subsequent processing. Thus, the drying device 9 contributes to drying the fabric F while suppressing color change in the primary drying processing.

In the above-described embodiment, the gas-fired ovens 4A to 4D and the heat press devices 5A and 5B are examples of the “dryer” of the present disclosure. The CPU 91 is an example of the “processor” of the present disclosure. The processes S12 to S14 and S22 to S24 are an examples of the “drying process” of the present disclosure. The drying device 9 is an example of the “drying device” of the present disclosure.

The oven process and the primary drying process are examples of the “primary drying process” of the present disclosure. The heat press process and the secondary drying process are examples of the “secondary drying process” of the present disclosure. The gas-fired ovens 4A to 4D are examples of the “non-contact dryer” of the present disclosure. The heat press devices 5A and 5B are examples of the “contact dryer” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below. The above-described embodiment and each of modified examples may be combined with each other insofar as no contradictions arise.

In the above-described embodiment, the number of the printers 2A to 2D is not limited to two. For example, the number of the printers 2A to 2D may be one, or may be three or more. Similarly, the number of the application device 3A, the gas-fired ovens 4A to 4D, the heat press devices 5A and 5B, and the post-processing devices 6A to 6F may be changed as appropriate.

In the above-described embodiment, the print system 1 may omit any configuration other than that of the drying device 9. For example, the print system 1 may omit the conveyance device 7 and the post-processing device 6A, and may include the application device 3A, the printer 2A, the gas-fired oven 4A, and the heat press device 5A.

In the above-described embodiment, the drying device 9 may omit the gas-fired ovens 4A to 4D. The drying device 9 may omit the heat press devices 5A and 5B.

In the above-described embodiment, the CPU 91 performs the primary drying processing using the gas-fired ovens 4A to 4D, and performs the secondary drying processing using the heat press devices 5A and 5B. In contrast, the CPU 91 may perform the primary drying processing using the heat press devices 5A and 5B, and may perform the secondary drying processing using the gas-fired ovens 4A to 4D.

The CPU 91 may perform the primary drying processing using the gas-fired ovens 4A to 4D, and may further perform the secondary drying processing using the gas-fired ovens 4A to 4D. In this case, the CPU 91 may perform the primary drying processing using a specific device from among the gas-fired ovens 4A to 4D, and may further perform the secondary drying processing continuously using the specific device. The CPU 91 may perform the primary drying processing using a specific device from among the gas-fired ovens 4A to 4D, and may perform the secondary drying processing using a different device from among the gas-fired ovens 4A to 4D.

The CPU 91 may perform the primary drying processing using the heat press devices 5A and 5B, and may further perform the secondary drying processing using the heat press devices 5A and 5B. In this case, the CPU 91 may perform the primary drying processing using a specific device from among the heat press devices 5A and 5B, and may further perform the secondary drying processing continuously using the specific device. The CPU 91 may perform the primary drying processing using a specific device from among the heat press devices 5A and 5B, and may perform the secondary drying processing using a different device from among the heat press devices 5A and 5B.

In the above-described embodiment, in place of the gas-fired ovens 4A to 4D, an electric oven may be employed, for example. In place of the gas-fired ovens 4A to 4D, a microwave oven may be employed, for example.

In the above-described embodiment, the heat press devices 5A and 5B may be mechanical, hydraulic, or servo-operated.

In the primary drying processing, the CPU 91 may stop the operation of the gas-fired oven 4A in a state in which the primary dryness factor is less than 79%. In the primary drying processing, the CPU 91 may stop the operation of the gas-fired oven 4A in a state in which the primary dryness factor exceeds 97%.

In the primary drying processing, the CPU 91 may stop the operation of the gas-fired oven 4A in a state in which the primary heat amount is less than 2500 J. In the primary drying processing, the CPU 91 may stop the operation of the gas-fired oven 4A in a state in which the primary heat amount exceeds 4100 J.

The control device 90 may be installed in any of the devices included in the print system 1, or may be disposed outside the devices included in the print system 1. For example, the control device 90 may be installed in the gas-fired oven 4A, or may be installed as a control board.

The fabric F may be other than 100% cotton. For example, the fabric F may contain less than 100% cotton. The fabric F may include other natural fibers, and may include synthetic fibers.

In place of the CPU 91, a microcomputer, an application specific integrated circuit (ASIC), a field programmable gate array (FPGA), or similar devices may be used as a processor. The main processing may be performed as distributed processing by multiple the processors.

Non-transitory storage media, such as the flash memory 92 may include any storage media capable of storing information, regardless of a period of storing the information. The non-transitory storage media may exclude transitory storage media (for example, transmitted signals). The control program may be downloaded from a server connected to a network (not shown in the drawings), in other words, transmitted as transmission signals and then stored in the flash memory 92. In this case, the control program may be stored in a non-transitory storage medium, such as an HDD of the server.

What is claimed is:

1. A drying device comprising:
a dryer configured to dry a fabric to which a pre-treatment liquid is applied prior to application of an ink containing a pigment to the fabric;
a processor; and
a memory storing computer-readable instructions that, when executed by the processor, cause the processor to perform a process comprising
drying processing of controlling the dryer to dry the fabric to which the pre-treatment liquid is applied until a target dryness factor is within a range of 82% to 95%, inclusive, wherein
the target dryness factor indicates a ratio of a target change amount to a weight of a target liquid,
the weight of the target liquid indicates a total obtained by adding together a weight of a solvent component contained in the pre-treatment liquid applied to the fabric at a time point preceding the drying processing and a weight of moisture contained in a region of the fabric to which the pre-treatment liquid is applied at a time point preceding application of the pre-treatment liquid to the fabric, and
the target change amount indicates an amount by which a weight of the region of the fabric changes as a result of the drying processing.

2. The drying device according to claim 1, wherein
in the drying processing, the computer-readable instructions instruct the processor to perform
primary drying processing of controlling the dryer to dry the fabric to which the pre-treatment liquid is applied, and
secondary drying processing of, subsequent to the primary drying processing, controlling the dryer to dry the fabric to which the pre-treatment liquid is applied until the target dryness factor is within the range of 82% to 95%, inclusive.

3. The drying device according to claim 2, wherein
the dryer includes
a non-contact dryer configured to dry the fabric using a non-contact method, and
a contact dryer configured to dry the fabric using a contact method, and
the computer-readable instructions instruct the processor to perform
the primary drying processing of controlling the non-contact dryer to dry the fabric to which the pre-treatment liquid is applied, and
the secondary drying processing of controlling the contact dryer to dry the fabric to which the pre-treatment liquid is applied.

4. The drying device according to claim 2, wherein
the computer-readable instructions instruct the processor to perform the primary drying processing of drying the fabric to which the pre-treatment liquid is applied until a primary dryness factor is within a range of 79% to 97%, inclusive,
the primary dryness factor indicates a ratio of a primary change amount to the weight of the target liquid, and
the primary change amount indicates an amount by which the weight of the region of the fabric changes as a result of the primary drying processing.

5. The drying device according to claim 3, wherein
the computer-readable instructions instruct the processor to perform
the primary drying processing of operating the non-contact dryer until the fabric to which the pre-treatment liquid is applied receives a heat amount within a range of 2500 J to 4100 J, inclusive.

6. A drying method for controlling a drying device, the drying device including a dryer configured to dry a fabric to which a pre-treatment liquid is applied prior to application of an ink containing a pigment to the fabric, the drying method, comprising:
drying processing of controlling the dryer to dry the fabric to which the pre-treatment liquid is applied until a target dryness factor is within a range of 82% to 95%, inclusive, wherein
the target dryness factor indicates a ratio of a target change amount to a weight of a target liquid,
the weight of the target liquid indicates a total obtained by adding together a weight of a solvent component contained in the pre-treatment liquid applied to the fabric, at a time point preceding the drying processing and a weight of moisture contained in a region of the fabric to which the pre-treatment liquid is applied at a time point preceding application of the pre-treatment liquid to the fabric, and
the target change amount indicates an amount by which a weight of the region of the fabric changes as a result of the drying processing.
